(19) United States
(12) Patent Application Publication
(10) Pub. No.: US 2026/0253092 A1
(43) Pub. Date: Aug. 27, 2026

(54) SYSTEM

(71) Applicant: SoftBank Group Corp., Tokyo (JP)

(72) Inventor: Jun OOKI, Tokyo (JP)

(73) Assignee: SoftBank Group Corp., Tokyo (JP)

(21) Appl. No.: 19/533,345

(22) Filed: Feb. 9, 2026

(30) Foreign Application Priority Data
Feb. 21, 2025 (JP) 2025-027076

(51) Int. Cl. G06Q 30/02

(52) U.S. Cl. CPC G06Q 30/02

(57) ABSTRACT

The system according to the embodiment includes a collection unit, an analysis unit, an examination unit, a generation unit, and a billing unit. The collection unit collects content of an advertising creative. The analysis unit analyzes the content collected by the collection unit and performs examination based on an examination criterion. The examination unit outputs an examination result based on the content analyzed by the analysis unit. The generation unit automatically generates an improvement of the advertising creative based on the examination result output by the examination unit. The billing unit collects rights-processed images or free images and performs billing according to usage frequency or a situation.

### CROSS-REFERENCE TO RELATED APPLICATION

The present application claims priority to and incorporates by reference the entire contents of Japanese Patent Application No. 2025-027076 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, examination and improvement of advertising creatives are performed manually, and there has been a problem that it is difficult to perform them efficiently.

### SUMMARY OF THE INVENTION

The system according to the embodiment includes a collection unit, an analysis unit, an examination unit, a generation unit, and a billing unit. The collection unit collects content of an advertising creative. The analysis unit analyzes the content collected by the collection unit and performs examination based on an examination criterion. The examination unit outputs an examination result based on the content analyzed by the analysis unit. The generation unit automatically generates an improvement of the advertising creative based on the examination result output by the examination unit. The billing unit collects rights-processed images or free images and performs billing according to usage frequency or a situation.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

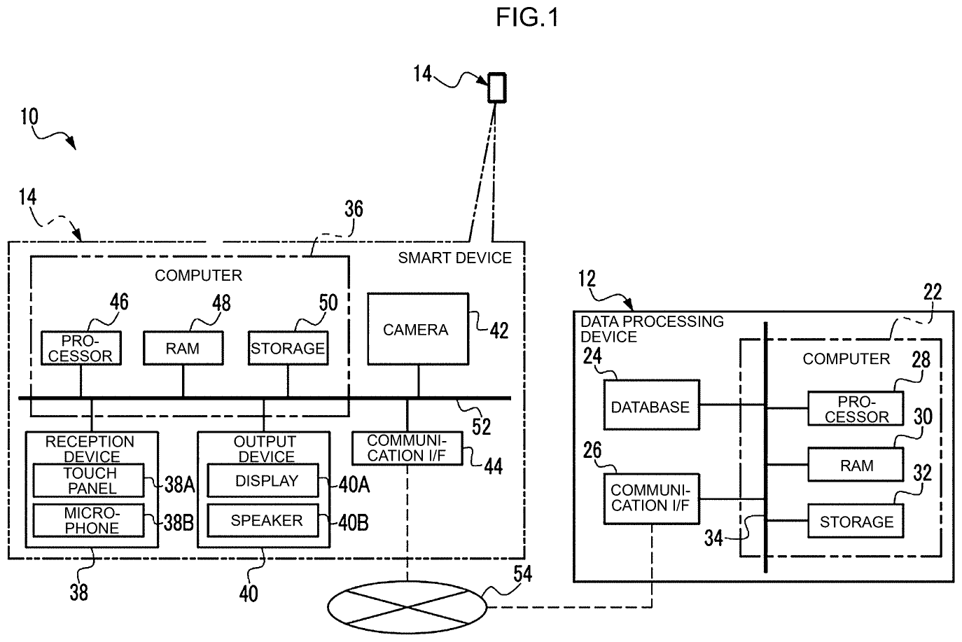

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

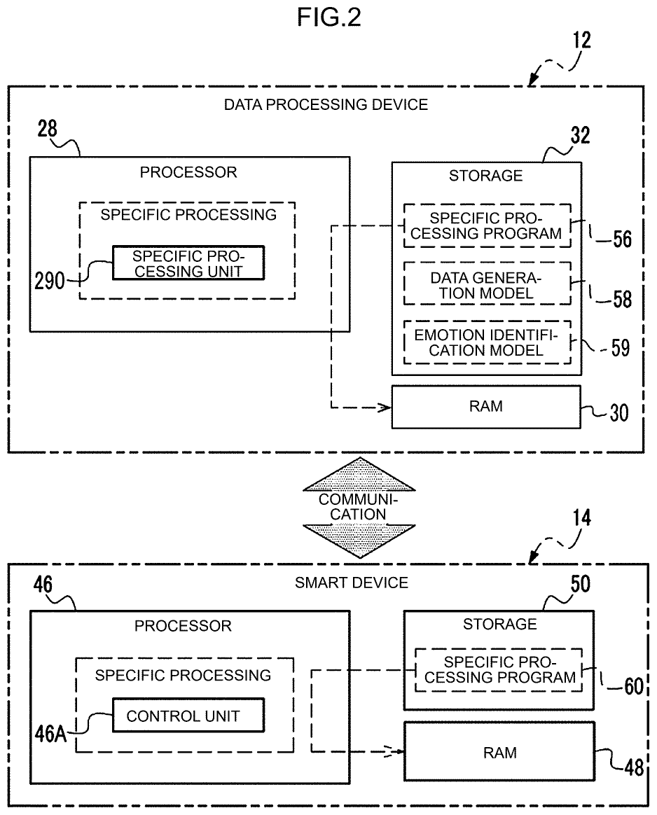

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system that provides a tool capable of automating examination checks of advertising creatives and further automatically generating improvements, and a platform capable of collecting rights-processed images or free images so that anyone can use them for advertising creatives and performing billing according to usage frequency or a situation. This system analyzes the content of an advertising creative and performs examination based on regulations. For example, it checks whether the content of the advertisement is legally problematic, whether it infringes copyright, whether appropriate expressions are used, and the like. This streamlines the examination process of advertising creatives. Next, based on the result of the examination check, an improvement of the advertising creative is automatically generated. This system analyzes the examination result and identifies necessary correction points. For example, it replaces a legally problematic expression with an appropriate expression, or replaces an image infringing copyright with a free image. In this way, the quality of the advertising creative can be improved. Furthermore, the system provides a platform capable of collecting rights-processed images or free images so that anyone can use them for advertising creatives and performing billing according to usage frequency or a situation. This platform collects images that can be used for advertising creatives and makes them easily accessible to users. For example, a user can search for and download an image they want to use for an advertising creative. In addition, since billing is performed according to usage frequency or a situation, the user can use necessary images at an appropriate price. With this mechanism, the examination check and improvement of advertising creatives are automated, and anyone can easily create high-quality advertising creatives. Also, by using the platform that collects rights-processed images or free images, the selection of images to be used for advertising creatives becomes easy, and they can be used at an appropriate price. Thereby, the examination check and improvement of advertising creatives are automated, and anyone can easily create high-quality advertising creatives. Specifically, the present system is realized by coordinating a plurality of neural network models built on a distributed cloud computing environment. The present system processes an input advertising creative (image data, text data, video data, etc.) as multidimensional tensor data, and extracts semantic features using a feature extractor corresponding to each modality. For example, for image data, a visual feature vector is generated using a Convolutional Neural Network (CNN) or a Vision Transformer, and for text data, a contextual embedding vector is generated using a Transformer-based Large Language Model. The present system integrates these feature vectors and calculates similarity (cosine similarity, etc.) with reference vectors obtained from a legal regulation database or a copyright database, thereby probabilistically determining the presence or absence of compliance violation. Furthermore, based on a violation score output as a determination result or a heat map indicating a corresponding portion, the present system generates an alternative creative in which the violation portion is locally corrected using generative AI such as a Generative Adversarial Network (GAN) or a Diffusion Model. At this time, the present system performs vector manipulation in a latent space so as to satisfy legal requirements while maintaining the aesthetic quality and appeal points of the original creative. In addition, the present platform manages rights information of images using blockchain technology or distributed ledger technology, and has a function of automatically executing micropayments according to usage status (number of displays, number of clicks, etc.) by smart contracts. This improves processing speed by several orders of magnitude compared to conventional manual visual confirmation and manual correction, while simultaneously ensuring uniformity of judgment criteria and transparency of rights processing.

The advertising creative examination system according to the embodiment comprises a collection unit, an analysis unit, an examination unit, a generation unit, and a billing unit. The collection unit collects content of an advertising creative. The collection unit can receive, for example, an upload from a user or provision from a partner. The collection unit can use various data collection methods to collect the content of the advertising creative. For example, the collection unit can collect advertising creatives on the Internet using web scraping technology. Also, the collection unit can collect an advertising creative uploaded by a user. Furthermore, the collection unit can collect an advertising creative provided by a partner. The analysis unit analyzes the content of the advertising creative collected by the collection unit and performs examination based on an examination criterion. The analysis unit can analyze text content of the advertising creative using, for example, natural language processing technology. Also, the analysis unit can analyze image content of the advertising creative using image recognition technology. Furthermore, the analysis unit can analyze audio content of the advertising creative using voice recognition technology. The examination unit outputs an examination result based on the content analyzed by the analysis unit. The examination unit checks, for example, whether the advertising creative is legally problematic, whether it infringes copyright, whether appropriate expressions are used, and the like. The examination unit evaluates the content of the advertising creative based on the examination criterion and outputs the examination result. The generation unit automatically generates an improvement of the advertising creative based on the examination result output by the examination unit. The generation unit, for example, replaces a legally problematic expression with an appropriate expression, or replaces an image infringing copyright with a free image. The generation unit can use various automatic generation algorithms to improve the quality of the advertising creative. For example, the generation unit can automatically generate text content of the advertising creative using natural language generation technology. Also, the generation unit can automatically generate image content of the advertising creative using image generation technology. Furthermore, the generation unit can automatically generate audio content of the advertising creative using voice generation technology. The billing unit collects rights-processed images or free images and performs billing according to usage frequency or a situation. The billing unit performs billing according to, for example, the usage frequency or situation of an image used for the advertising creative. The billing unit enables a user to search for and download an image they want to use for the advertising creative. The billing unit provides images at an appropriate price according to usage frequency or a situation. Thereby, the advertising creative examination system according to the embodiment automates the examination check and improvement of advertising creatives, allowing anyone to easily create high-quality advertising creatives. Specifically, the present collection unit is implemented as an API gateway or a crawling bot group, and executes a preprocessing pipeline that periodically and automatically acquires unstructured data (HTML, image files, video streams) on the Internet and stores it in a data lake. The present analysis unit is a deep learning inference engine operating on a GPU cluster, which normalizes and tokenizes input multimedia data, and then inputs it to an encoder dedicated to each modality (for example, BERT for text, ResNet for images, Wav2Vec for audio) to map it to a high-dimensional feature space. The present examination unit compares the mapped feature vector with cluster centers of pre-learned “violation patterns” and performs anomaly detection based on Euclidean distance or Mahalanobis distance, thereby calculating a probability of legal risk or copyright infringement. The present generation unit receives a mask image of a violation region identified by the examination unit and a correction instruction prompt as input, drives an image generation model using inpainting technology or a Sequence-to-Sequence model for text rewriting, and outputs a correction proposal maintaining context consistency. The present billing unit comprises a transaction processing engine that tracks digital watermarks or fingerprints embedded in each image asset, aggregates usage logs in real time, and dynamically performs billing calculation. These units are loosely coupled by a microservice architecture and are capable of autoscaling according to load by a container orchestration system.

A system comprising a setting unit configured to set an examination criterion. The setting unit sets the examination criterion. The examination criterion includes, for example, evaluation items such as whether the advertising creative is legally problematic, whether it infringes copyright, and whether appropriate expressions are used. The setting unit can use various criterion setting methods to set the examination criterion. For example, the setting unit can analyze past examination data and set an optimal examination criterion. Also, the setting unit can adjust the examination criterion based on user feedback. Furthermore, the setting unit can update the examination criterion according to legal changes or industry trends. Thereby, by setting the examination criterion, the examination accuracy of the advertising creative is improved. Specifically, the present setting unit includes a model management module that manages the examination criterion not only as natural language rules but also numerically as weight parameters of a neural network or thresholds of a decision tree. The present setting unit periodically executes a re-learning process using past examination history data (pairs of input creatives and examination results) as training data, and updates a decision boundary of the model, thereby optimizing the examination criterion. Also, the present setting unit has a function of analyzing new legal regulation documents by natural language processing, automatically extracting feature vectors of prohibited word lists or caution-required image patterns, and adding them to a knowledge base to dynamically update the examination criterion. Furthermore, the present setting unit uses a reinforcement learning algorithm to adaptively adjust a strictness parameter of the examination criterion by taking a correction acceptance rate or feedback from a user as a reward signal. This enables high-precision examination corresponding to subtle nuances or changes in trends that cannot be handled by static rule bases.

A system comprising an algorithm unit configured to execute an automatic generation algorithm for the improvement. The algorithm unit executes the automatic generation algorithm for the improvement. The algorithm unit can automatically generate text content of the advertising creative using, for example, natural language generation technology. Also, the algorithm unit can automatically generate image content of the advertising creative using image generation technology. Furthermore, the algorithm unit can automatically generate audio content of the advertising creative using voice generation technology. The algorithm unit can use various automatic generation algorithms to improve the quality of the advertising creative. For example, the algorithm unit uses generative AI to analyze the content of the advertising creative and identify necessary correction points. The generative AI, for example, replaces a legally problematic expression with an appropriate expression, or replaces an image infringing copyright with a free image. Thereby, by executing the automatic generation algorithm, the improvement of the advertising creative is efficiently performed. Specifically, the present algorithm unit is a calculation resource management unit that executes a generation model such as a Large Language Model (LLM) or a Diffusion Model in an inference mode. The present algorithm unit performs a vector operation (attribute editing) on a latent representation of the input creative so as to cancel a violation attribute pointed out by the examination unit, and reconstructs it into a real data space through a decoder. For example, in text generation, a model using a Transformer architecture identifies a context containing a violation term by an attention mechanism, and autoregressively generates a token sequence replaced with a compliance-compliant term while maintaining semantic equivalence in the context. In image generation, using a model such as Stable Diffusion, with a mask image specifying a violation portion and a text prompt describing correction content as input, local image rewriting is performed through a noise removal process. The present algorithm unit has a self-evaluation loop function of creating a plurality of generation candidates, inputting them to the examination model again to perform scoring, and selecting a candidate with the highest score (high quality and no violation) as a final output.

A system comprising a management unit configured to manage a collection method of images. The management unit manages the collection method of images. The management unit can receive, for example, an upload from a user or provision from a partner. The management unit can use various management methods to manage the collection method of images used for the advertising creative. For example, the management unit can set the type of data to be collected and details of the collection method. Also, the management unit can evaluate the quality of collected images and select an appropriate image. Furthermore, the management unit can perform billing according to usage frequency or a situation of the collected images. Thereby, by managing the collection method of images, selection of images to be used for the advertising creative becomes easy. Specifically, the present management unit functions as an orchestrator that controls scheduling of data collection tasks, management of API rate limiting, and rotation of proxy servers. The present management unit dynamically determines an optimal crawling frequency and number of parallel processes for each collection target website or API endpoint, realizing efficient data collection while distributing server load. Also, the present management unit automatically executes preprocessing filtering such as resolution check, blur detection, and deduplication (by hash value comparison) on the collected image data, and stores only high-quality data suitable for learning or use in a database. Furthermore, the present management unit indexes metadata (source, license information, acquisition date and time) of each image as structured data, and maintains and manages a data catalog so that fast queries are possible in subsequent search and rights processing.

A system comprising a system unit configured to manage a billing system. The system unit manages the billing system. The system unit performs billing according to, for example, usage frequency or a situation of an image used for the advertising creative. The system unit can use various management methods to manage the billing system. For example, the system unit can set a timing of billing and a criterion for billing. Also, the system unit can analyze a usage status of a user and perform an appropriate billing setting. Furthermore, the system unit can adjust a setting of the billing system and perform billing efficiently. Thereby, by managing the billing system, appropriate billing according to usage frequency or a situation is performed. Specifically, the present system unit uses distributed ledger technology (blockchain) or a high-reliability transaction database to record all image usage events (display, click, download, modification, etc.) in a tamper-proof format. The present system unit executes a smart contract or a rule engine, and immediately calculates a billing amount when a usage event occurs based on predefined billing logic (for example, impression unit price, term license, performance-based type, etc.). Also, the present system unit is equipped with a fraud detection algorithm that performs time-series analysis of usage patterns for each user and stops the billing process or issues a warning when abnormal usage (unauthorized download, scraping, etc.) is detected. Furthermore, the present system unit has a function of adopting a dynamic pricing model and varying a unit price in real time according to demand (popularity) or scarcity of an image, thereby aiming to maximize revenue of the entire platform.

The collection unit can estimate an emotion of a user and adjust a collection timing of the advertising creative based on the estimated emotion of the user. For example, when the user feels stress, the collection unit delays the collection timing to reduce the burden on the user. Also, when the user is relaxed, the collection unit can advance the collection timing to perform collection efficiently. Furthermore, when the user is in a hurry, the collection unit can optimize the collection timing to perform collection quickly. Thereby, by adjusting the collection timing according to the emotion of the user, the burden on the user can be reduced and collection can be performed efficiently. The estimation of emotion is realized using an emotion estimation function using, for example, an emotion engine or generative AI. The generative AI is, for example, text generative AI (e.g., LLM) or multimodal generative AI, but is not limited to such examples. Specifically, the present collection unit acquires operation logs on a user interface (mouse movement speed, keystroke interval, click strength, etc.) and biometric data such as camera images and microphone audio acquired with user permission as input data. The present collection unit inputs these input data as time-series data to a Recurrent Neural Network (RNN), Long Short-Term Memory (LSTM), or a Transformer-based emotion recognition model, and outputs a probability vector or score representing the user's current emotional state (stress, relaxation, impatience, etc.). Based on the output emotion score, the present collection unit dynamically changes parameters (polling interval, timeout setting, number of parallel processes) controlling the execution schedule of the data collection process. For example, when a stress value exceeds a predetermined threshold, control is performed to limit background data communication bandwidth to prioritize UI responsiveness or suppress popup notifications. This provides a technical effect that the computer system adapts to the user's psychological state and optimizes resource allocation.

The collection unit can analyze a past advertising creative submission history of a user and select an appropriate collection method. For example, the collection unit analyzes a tendency of advertising creatives submitted by the user in the past and proposes an optimal collection method. Also, the collection unit can perform collection in a specific time zone from the past submission history of the user. Furthermore, the collection unit can customize the collection method based on the past submission history of the user. Thereby, by analyzing the past submission history, an optimal collection method can be proposed and collection can be performed efficiently. Part or all of the above-described processing in the collection unit may be performed using, for example, AI, or may be performed without using AI. For example, the collection unit can input past submission history data of the user to generative AI and cause the generative AI to execute selection of an optimal collection method. Specifically, the present collection unit converts past submission data (file format, size, submission time, content category) for each user into feature vectors and accumulates them in a user profile database. The present collection unit uses a clustering algorithm (K-means, etc.) or a time-series prediction model (ARIMA, Prophet, etc.) to learn the behavior pattern of the user and predict the next submission time and content. For example, if there is a tendency for a specific user to upload a large amount of video advertisements at the end of every month, the present collection unit performs provisioning such as reserving upload bandwidth in advance or warming up a GPU instance for video processing in accordance with the predicted timing. Also, the present collection unit inputs past history data and current context information to a Large Language Model (LLM), and uses the inference ability of the LLM to generate a proposal for an advanced collection strategy such as “API integration should be recommended over FTP transfer for this user” and reflect it in the system setting.

The collection unit can perform filtering based on a current project or a field of interest of a user when collecting the advertising creative. For example, the collection unit preferentially collects advertising creatives related to a project on which the user is currently working. Also, the collection unit can collect highly relevant advertising creatives based on the field of interest of the user. Furthermore, the collection unit can adjust advertising creatives to be collected according to the project progress status of the user. Thereby, by performing filtering based on the project or field of interest of the user, highly relevant advertising creatives can be efficiently collected. Part or all of the above-described processing in the collection unit may be performed using, for example, AI, or may be performed without using AI. For example, the collection unit can input data regarding the project or field of interest of the user to generative AI and cause the generative AI to execute filtering. Specifically, the present collection unit acquires data of a project management tool on which the user is currently working, and context information such as recent search queries and browsing history, and generates a topic vector (embedding representation) representing the subject or interest area of the project using a natural language processing model (BERT, etc.). At the same time, the present collection unit similarly generates feature vectors representing content for a large number of advertising creatives that are collection candidates. The present collection unit calculates cosine similarity between the user's topic vector and the feature vector of the advertising creative, and executes filtering processing to selectively collect or preferentially display only creatives whose similarity exceeds a predetermined threshold. Furthermore, the present collection unit determines a progress phase (planning stage, production stage, examination stage) of the project by a classification model, and automatically switches a collection policy according to the phase, such as prioritizing images giving diverse inspiration in the planning stage and prioritizing similar cases or advertisements of competitors in the examination stage.

The collection unit can estimate an emotion of a user and determine a priority of the advertising creative to be collected based on the estimated emotion of the user. For example, when the user feels stress, the collection unit postpones an advertising creative with low importance. Also, when the user is relaxed, the collection unit can preferentially collect an advertising creative with high importance. Furthermore, when the user is in a hurry, the collection unit can prioritize an advertising creative that needs to be collected quickly. Thereby, by determining the priority of the advertising creative to be collected according to the emotion of the user, collection can be performed efficiently. The estimation of emotion is realized using an emotion estimation function using, for example, an emotion engine or generative AI. The generative AI is, for example, text generative AI (e.g., LLM) or multimodal generative AI, but is not limited to such examples. Part or all of the above-described processing in the collection unit may be performed using, for example, AI, or may be performed without using AI. For example, the collection unit can input emotion data of the user to generative AI and cause the generative AI to execute determination of the priority of the advertising creative to be collected. Specifically, the present collection unit comprises a priority calculation model that receives an emotional state (for example, coordinates on a two-dimensional space of arousal and valence) estimated from the user's biometric information or input operation pattern, and metadata (urgency, importance, deadline) of each advertising creative as input. This model is, for example, a neural network or a fuzzy inference system that has learned a rule such as “lower the weight of low-importance tasks during high stress”. The present collection unit dynamically reorders a priority queue managing collection tasks based on the calculated priority score. Thereby, in a state where the user's cognitive load is high, the system autonomously controls the inflow of information and optimizes the data flow so as to present only important information within a range processable by the user.

The collection unit can preferentially collect highly relevant creatives based on geographical location information of a user when collecting the advertising creative. For example, the collection unit preferentially collects advertising creatives related to a region based on the current location of the user. Also, the collection unit can collect highly relevant advertising creatives with reference to the past movement history of the user. Furthermore, the collection unit can update the geographical location information of the user in real time and collect an optimal advertising creative. Thereby, by considering the geographical location information of the user, highly relevant advertising creatives can be efficiently collected. Part or all of the above-described processing in the collection unit may be performed using, for example, AI, or may be performed without using AI. For example, the collection unit can input geographical location information data of the user to generative AI and cause the generative AI to execute collection of highly relevant advertising creatives. Specifically, the present collection unit converts latitude and longitude information of the user acquired from GPS, a Wi-Fi access point, or an IP address into a spatial index such as Geohash. The present collection unit calculates a geographical distance between target region information associated with the advertising creative and the location information of the user, and performs scoring using the inverse of the distance as a weight. Furthermore, the present collection unit has a function of inputting time-series data (movement trajectory) of location information to a Recurrent Neural Network (RNN), predicting the user's next destination or activity area, and prefetching (look-ahead collection) advertising creatives related to the predicted area. This enables data provision with minimized latency, such as making relevant creatives immediately available when the user arrives at a specific place.

The collection unit can analyze social media activity of a user and collect a relevant creative when collecting the advertising creative. For example, the collection unit analyzes posted content on the user's social media and collects a relevant advertising creative. Also, the collection unit can collect a highly relevant advertising creative with reference to followers or accounts followed on the user's social media. Furthermore, the collection unit can collect an optimal advertising creative based on the activity history on the user's social media. Thereby, by analyzing the social media activity of the user, highly relevant advertising creatives can be efficiently collected. Part or all of the above-described processing in the collection unit may be performed using, for example, AI, or may be performed without using AI. For example, the collection unit can input social media activity data of the user to generative AI and cause the generative AI to execute collection of a relevant advertising creative. Specifically, the present collection unit acquires posted text, images, “like” history, and follow relationship graphs from the user's social media account via an API, and extracts the user's interests and characteristics of the community to which they belong as an embedding representation using a Graph Neural Network (GNN). The present collection unit uses this embedding representation to identify trending hashtags or visual styles, and automatically crawls and collects advertising creatives matching them from an external database or SNS. Also, the present collection unit learns the composition and color usage of images preferred by the user by multimodal analysis, and selects a creative having similar aesthetic features through a recommender system.

The analysis unit can estimate an emotion of a user and adjust a representation method of analysis based on the estimated emotion of the user. For example, when the user is nervous, the analysis unit provides a simple and highly visible analysis result. Also, when the user is relaxed, the analysis unit can provide a detailed analysis result. Furthermore, when the user is in a hurry, the analysis unit can provide an analysis result capturing key points. Thereby, by adjusting the representation method of analysis according to the emotion of the user, an analysis result easy for the user to understand can be provided. The estimation of emotion is realized using an emotion estimation function using, for example, an emotion engine or generative AI. The generative AI is, for example, text generative AI (e.g., LLM) or multimodal generative AI, but is not limited to such examples. Part or all of the above-described processing in the analysis unit may be performed using, for example, AI, or may be performed without using AI. For example, the analysis unit can input emotion data of the user to generative AI and cause the generative AI to execute adjustment of the representation method of analysis. Specifically, the present analysis unit comprises a UI generation engine that dynamically switches a display template or CSS style according to an output (emotion label or arousal level) from the emotion estimation module when rendering analysis result data (numerical value, text, graph, etc.) on a user interface (UI). For example, when it is determined that the user's cognitive load is high (nervous state), the present analysis unit selects a dashboard mode that omits detailed text explanation and displays only important indicators in a large size, and executes a summarization algorithm that coarsens the granularity of information. Conversely, when it is determined that the user is taking exploratory action (relaxed state), a rich display mode including drill-down capable detailed data and correlation graphs is selected. This processing is realized by Adaptive User Interface (AUI) technology that optimizes the presentation format of information according to the user's state.

The analysis unit can adjust a level of detail of analysis based on an importance of the advertising creative when performing analysis. For example, the analysis unit performs detailed analysis for an advertising creative with high importance. Also, the analysis unit can perform simplified analysis for an advertising creative with low importance. Furthermore, the analysis unit can adjust the depth of analysis according to the importance of the advertising creative. Thereby, by adjusting the level of detail of analysis based on the importance of the advertising creative, analysis can be performed efficiently. Part or all of the above-described processing in the analysis unit may be performed using, for example, AI, or may be performed without using AI. For example, the analysis unit can input importance data of the advertising creative to generative AI and cause the generative AI to execute adjustment of the level of detail of analysis. Specifically, the present analysis unit has a scoring module that calculates an importance score from metadata (budget scale, scheduled number of distributions, client rank, etc.) of the input advertising creative. Based on this importance score, the present analysis unit dynamically changes the size of the neural network model to be used and the number of inference steps. For example, for a high-importance creative, a high-precision large-scale model with a large number of parameters (for example, an ensemble learning model) is used to perform pixel-level segmentation or detailed emotion analysis. On the other hand, for a low-importance creative, a lightweight distilled model or quantized model is used to perform only main object detection, thereby optimizing the allocation of calculation resources. This provides a technical effect of maximizing the balance between the throughput of the entire system and analysis accuracy within limited GPU resources.

The analysis unit can apply a different analysis algorithm according to a category of the advertising creative when performing analysis. For example, if the advertising creative is text-based, the analysis unit applies a natural language processing algorithm. Also, if the advertising creative is image-based, the analysis unit can apply an image analysis algorithm. Furthermore, if the advertising creative is video-based, the analysis unit can apply a video analysis algorithm. Thereby, by applying a different analysis algorithm according to the category of the advertising creative, the accuracy of analysis is improved. Part or all of the above-described processing in the analysis unit may be performed using, for example, AI, or may be performed without using AI. For example, the analysis unit can input category data of the advertising creative to generative AI and cause the generative AI to execute application of a different analysis algorithm. Specifically, the present analysis unit comprises a dispatcher that analyzes the MIME type or header information of input data and determines the modality (text, still image, video, audio) of the data. For text data, syntax analysis, semantic analysis, and emotion analysis are performed using a Transformer model such as BERT or GPT. For image data, object detection, scene recognition, and OCR (Optical Character Recognition) are performed using a CNN (ResNet, EfficientNet, etc.) or a Vision Transformer. For video data, spatiotemporal features are extracted using a 3D-CNN or Video Swin Transformer to perform action recognition or scene segmentation. Furthermore, for a multimedia advertisement containing a plurality of these modalities, the present analysis unit executes cross-modal analysis that evaluates consistency between an image and text (for example, degree of match between an object in the image and a caption) using a multimodal learning model (CLIP, etc.).

The analysis unit can estimate an emotion of a user and adjust a length of analysis based on the estimated emotion of the user. For example, when the user is in a hurry, the analysis unit provides a short analysis result capturing key points. Also, when the user is relaxed, the analysis unit can provide a detailed analysis result. Furthermore, when the user is excited, the analysis unit can provide a visually stimulating analysis result. Thereby, by adjusting the length of analysis according to the emotion of the user, an optimal analysis result for the user can be provided. The estimation of emotion is realized using an emotion estimation function using, for example, an emotion engine or generative AI. The generative AI is, for example, text generative AI (e.g., LLM) or multimodal generative AI, but is not limited to such examples. Part or all of the above-described processing in the analysis unit may be performed using, for example, AI, or may be performed without using AI. For example, the analysis unit can input emotion data of the user to generative AI and cause the generative AI to execute adjustment of the length of analysis. Specifically, the present analysis unit includes a natural language processing model that executes an Automatic Summarization task on text data generated as an analysis result. The present analysis unit dynamically controls an output token count limit (Max Tokens) or compression rate of the summarization model based on a “impatience” parameter of the user input from the emotion estimation unit. For example, when the impatience is high, only important sentences are output in bullet points by Extractive Summarization, and when the impatience is low, fluent sentences including background explanation are generated by Abstractive Summarization. Also, when the user's “excitement” is high, the present analysis unit also adjusts parameters of visual presentation, such as highlighting keywords included in the analysis result or adding dynamic graph animation.

The analysis unit can determine a priority of analysis based on a submission time of the advertising creative when performing analysis. For example, the analysis unit preferentially analyzes a recently submitted advertising creative. Also, the analysis unit can postpone an advertising creative with an old submission time. Furthermore, the analysis unit can adjust the order of analysis based on the submission time. Thereby, by determining the priority of analysis based on the submission time of the advertising creative, analysis can be performed efficiently. Part or all of the above-described processing in the analysis unit may be performed using, for example, AI, or may be performed without using AI. For example, the analysis unit can input submission time data of the advertising creative to generative AI and cause the generative AI to execute determination of the priority of analysis. Specifically, the present analysis unit comprises a job scheduler that manages metadata (submission timestamp, deadline time, SLA level) of each analysis job. This scheduler adopts an EDF (Earliest Deadline First) algorithm or a weighted round robin method, and assigns a high priority score to a job with a new submission time or an approaching deadline. Furthermore, the present analysis unit performs optimization to minimize the average waiting time of the entire system by predicting an estimated processing time of each job using a machine learning model and combining it with an SJF (Shortest Job First) strategy that preferentially processes a job that finishes in a short time. This makes it possible to quickly complete advertising examination for a new campaign requiring real-time performance.

The analysis unit can adjust an order of analysis based on a relevance of the advertising creative when performing analysis. For example, the analysis unit preferentially analyzes a highly relevant advertising creative. Also, the analysis unit can postpone an advertising creative with low relevance. Furthermore, the analysis unit can adjust the order of analysis based on the relevance of the advertising creative. Thereby, by adjusting the order of analysis based on the relevance of the advertising creative, analysis can be performed efficiently. Part or all of the above-described processing in the analysis unit may be performed using, for example, AI, or may be performed without using AI. For example, the analysis unit can input relevance data of the advertising creative to generative AI and cause the generative AI to execute adjustment of the order of analysis. Specifically, the present analysis unit maps a plurality of waiting advertising creatives onto a vector space and performs clustering (DBSCAN, K-means, etc.) to identify a creative group (cluster) having similar content or attributes. The present analysis unit reorders the analysis order so as to continuously batch process creatives belonging to the same cluster. This makes it possible to improve the cache hit rate of the analysis model or perform common feature extraction processing at once, significantly improving calculation efficiency. Also, the present analysis unit has a function of calculating semantic similarity with external trend data and dynamically changing the order of the queue based on the score in order to raise the priority of a creative related to a currently trending topic.

The examination unit can estimate an emotion of a user and adjust a criterion for examination based on the estimated emotion of the user. For example, when the user is nervous, the examination unit relaxes the examination criterion. Also, when the user is relaxed, the examination unit can make the examination criterion strict. Furthermore, when the user is in a hurry, the examination unit can optimize the examination criterion. Thereby, by adjusting the criterion for examination according to the emotion of the user, appropriate examination can be performed. The estimation of emotion is realized using an emotion estimation function using, for example, an emotion engine or generative AI. The generative AI is, for example, text generative AI (e.g., LLM) or multimodal generative AI, but is not limited to such examples. Part or all of the above-described processing in the examination unit may be performed using, for example, AI, or may be performed without using AI. For example, the examination unit can input emotion data of the user to generative AI and cause the generative AI to execute adjustment of the examination criterion. Specifically, the present examination unit comprises an adjustment mechanism that dynamically shifts a threshold in an output layer of a classification model performing examination judgment according to a state vector of the user input from the emotion estimation unit. For example, when the user is in a state of “high stress” and “just before deadline”, the present examination unit lowers a judgment threshold for a minor guideline violation (for example, deviation from recommended color usage) other than legally essential items, and keeps it at a warning level, thereby temporarily improving the examination passing rate. Conversely, when the user is in a learning mode or a quality improvement mode, the threshold is raised to perform strict examination pointing out even minute improvement points. This adjustment is controlled by a reinforcement learning agent that optimizes the balance between risk tolerance and user experience.

The examination unit can improve accuracy of examination based on an interrelationship of advertising creatives when performing examination. For example, the examination unit analyzes relevance between advertising creatives and improves the accuracy of examination. Also, the examination unit can adjust an examination result in consideration of the interrelationship of advertising creatives. Furthermore, the examination unit can improve the accuracy of examination based on the interrelationship of advertising creatives. Accordingly, by considering the interrelationship of advertising creatives, the accuracy of examination is improved. Part or all of the above-described processing in the examination unit may be performed using, for example, AI, or may be performed without using AI. For example, the examination unit can input interrelationship data of advertising creatives to a generative AI and cause the generative AI to execute improvement of the accuracy of examination. Specifically, the present examination unit performs a comprehensive analysis including not only a single creative but also variation images within the same campaign and content of a linked landing page (LP). The present examination unit uses a cross-modal inference model that vectorizes each of an advertising banner image and text content of the LP and verifies semantic consistency (Entailment) between both. For example, if there is a description incurring a cost in the LP despite claiming “free” in the banner, it is detected as a mutual contradiction and scored as a misrepresentation risk. In addition, the present examination unit compares with similar creatives that have passed examination in the past, and uses a graph neural network to propagate relationships between creatives and correct confidence of determination in order to output a consistent examination result.

The examination unit can perform examination in consideration of attribute information of a submitter of the advertising creative when performing examination. For example, the examination unit performs examination with reference to a past examination history of the submitter. Also, the examination unit can perform examination in consideration of the attribute information (age, gender, occupation, etc.) of the submitter. Furthermore, the examination unit can improve accuracy of examination based on the attribute information of the submitter. Accordingly, by considering the attribute information of the submitter, the accuracy of examination is improved. Part or all of the above-described processing in the examination unit may be performed using, for example, AI, or may be performed without using AI. For example, the examination unit can input attribute information data of the submitter to a generative AI and cause the generative AI to perform execution of examination. Specifically, the present examination unit acquires a trust score linked to an ID of the submitter from a database and uses this as a part of an input feature amount of an examination model. The trust score is calculated based on a past examination pass rate, the number of violations, quickness of modification response, and the like. The present examination unit executes condition branching logic that applies sampling inspection or simplified examination to speed up processing for submissions from highly reliable submitters (e.g., certified agencies or skilled designers), while applying a detailed examination flow requiring 100% inspection or a secondary check by a human for new users or submitters with a history of serious violations in the past. In addition, the present examination unit automatically selects and applies a legal regulation filter (e.g., Pharmaceutical and Medical Device Act check for medical field, Act against Unjustifiable Premiums and Misleading Representations check for financial field) to be applied according to an industry attribute of the submitter.

The examination unit can estimate an emotion of a user and adjust an order of displaying a result of examination based on the estimated emotion of the user. For example, when the user is nervous, the examination unit displays an important examination result first. Also, when the user is relaxed, the examination unit can display a detailed examination result later. Furthermore, when the user is in a hurry, the examination unit can display an examination result capturing key points first. Accordingly, by adjusting the display order of the examination result according to the emotion of the user, an examination result that is easy for the user to understand can be provided. Estimation of the emotion is realized using an emotion estimation function using, for example, an emotion engine or a generative AI. The generative AI is, for example, a text generation AI (e.g., LLM) or a multimodal generative AI, but is not limited to such examples. Part or all of the above-described processing in the examination unit may be performed using, for example, AI, or may be performed without using AI. For example, the examination unit can input emotion data of the user to a generative AI and cause the generative AI to execute adjustment of the display order of the examination result. Specifically, the present examination unit includes a learning to rank model that performs weighting based on an importance score and an emotional state of the user for a plurality of detected pointed-out items (error, warning, information) and generates a display ranking. When the user is in a “frustrated” state, the present examination unit generates UI structure data so as to place only a “Critical Error” requiring modification at the top of a list and display minor modification proposals in a collapsed manner. On the other hand, when the user is in a state of high motivation for “learning”, the present examination unit preferentially expands detailed information including reasons for errors and educational content for improvement, and presents information in an order that supports skill improvement of the user.

The examination unit can perform examination based on a geographical distribution of advertising creatives when performing examination. For example, the examination unit analyzes the geographical distribution of advertising creatives and performs examination. Also, the examination unit can perform examination in consideration of characteristics of advertising creatives for each region. Furthermore, the examination unit can improve accuracy of examination based on the geographical distribution. Accordingly, by considering the geographical distribution of advertising creatives, the accuracy of examination is improved. Part or all of the above-described processing in the examination unit may be performed using, for example, AI, or may be performed without using AI. For example, the examination unit can input geographical distribution data of advertising creatives to a generative AI and cause the generative AI to perform execution of examination. Specifically, the present examination unit identifies a country or region (geolocation) to be an advertisement distribution target, and performs examination with reference to a knowledge base (local rule DB) regarding laws, cultures, and religious taboos specific to the region. The present examination unit determines whether an image or text of the input creative contains an expression considered inappropriate in a specific region (e.g., a specific gesture, clothing, political symbol) using a region-specific model that has learned a context for each region. For example, when exposure of skin permitted in a certain country is prohibited in another country, the present examination unit applies an appropriate determination criterion based on distribution area information to prevent false detection or oversight.

The examination unit can refer to related literature of the advertising creative to improve accuracy of examination when performing examination. For example, the examination unit refers to literature related to the advertising creative and improves the accuracy of examination. Also, the examination unit can adjust an examination result based on the related literature. Furthermore, the examination unit can improve the accuracy of examination by referring to the related literature. Accordingly, by referring to the related literature, the accuracy of examination is improved. Part or all of the above-described processing in the examination unit may be performed using, for example, AI, or may be performed without using AI. For example, the examination unit can input related literature data of the advertising creative to a generative AI and cause the generative AI to perform execution of examination. Specifically, the present examination unit adopts a RAG (Retrieval-Augmented Generation) architecture, and searches for and acquires external knowledge such as legal provisions, past judicial precedents, industry guidelines, and cases of competitors related to content of the advertising creative from a vector database in real time. The present examination unit inputs text embeddings of the acquired related literature and a feature vector of the creative to be examined to a large language model (LLM), and causes the LLM to perform inference asking “Does this advertisement expression violate in light of the reference literature (Article X)?”. This makes it possible to prevent hallucination depending only on internal knowledge of the model and output a specific and highly accurate examination result based on evidence.

The generation unit can estimate an emotion of a user and adjust a representation method of the advertising creative to be generated based on the estimated emotion of the user. For example, when the user is relaxed, the generation unit uses a soft representation method. Also, when the user is in a hurry, the generation unit can use a concise representation method. Furthermore, when the user is excited, the generation unit can use a visually stimulating representation method. Accordingly, by adjusting the representation method of the advertising creative according to the emotion of the user, an advertising creative optimal for the user can be generated. Estimation of the emotion is realized using an emotion estimation function using, for example, an emotion engine or a generative AI. The generative AI is, for example, a text generation AI (e.g., LLM) or a multimodal generative AI, but is not limited to such examples. Part or all of the above-described processing in the generation unit may be performed using, for example, AI, or may be performed without using AI. For example, the generation unit can input emotion data of the user to a generative AI and cause the generative AI to execute adjustment of the representation method of the advertising creative. Specifically, the present generation unit includes a prompt engineering module that automatically adds style modifiers corresponding to the emotional state of the user to an input prompt to an image generation model (Stable Diffusion, etc.) or a text generation model (GPT, etc.). For example, when the user is in a “relaxed” state, keywords such as “pastel colors, soft lighting, calm atmosphere” are added to the prompt to adjust a tone of a generated image. Also, in text generation, parameters (Temperature, Top-p) for controlling a tone of voice are adjusted according to the emotion of the user to optimize an output format such as a friendly colloquial style or a concise bulleted list.

The generation unit can adjust a level of detail of generation based on an importance of the advertising creative when performing generation. For example, the generation unit performs detailed generation for an advertising creative with high importance. Also, the generation unit can perform simplified generation for an advertising creative with low importance. Furthermore, the generation unit can adjust a depth of generation according to the importance of the advertising creative. Accordingly, by adjusting the level of detail of generation based on the importance of the advertising creative, generation can be performed efficiently. Part or all of the above-described processing in the generation unit may be performed using, for example, AI, or may be performed without using AI. For example, the generation unit can input importance data of the advertising creative to a generative AI and cause the generative AI to execute adjustment of the level of detail of generation. Specifically, the present generation unit has control logic that varies the number of sampling steps (Denoising Steps) in a diffusion model and resolution of an image according to an importance score of the creative. For a creative with high importance (e.g., a main visual for a national campaign), a large number of steps (e.g., 100 steps or more) and a high resolution (e.g., 4K) setting are applied, and upscaling processing and detail refinement are additionally performed to output a highest quality product. On the other hand, for a creative with low importance (e.g., a rough draft for internal confirmation), a small number of steps (e.g., 20 steps or less) and a low resolution setting are applied to prioritize generation speed, thereby reducing calculation cost and realizing a quick feedback loop.

The generation unit can apply a different generation algorithm according to a category of the advertising creative when performing generation. For example, when the advertising creative is text-based, the generation unit applies a natural language generation algorithm. Also, when the advertising creative is image-based, the generation unit can apply an image generation algorithm. Furthermore, when the advertising creative is video-based, the generation unit can apply a video generation algorithm. Accordingly, by applying a different generation algorithm according to the category of the advertising creative, accuracy of generation is improved. Part or all of the above-described processing in the generation unit may be performed using, for example, AI, or may be performed without using AI. For example, the generation unit can input category data of the advertising creative to a generative AI and cause the generative AI to execute application of a different generation algorithm. Specifically, the present generation unit functions as a model router that selects an optimal generation model based on an input modification instruction and a type of target media to construct a pipeline. For modification of a text advertisement, a large language model (LLM) excellent in context understanding is used to generate an alternative plan for a catchphrase. For modification of a banner image, an image generation model having an inpainting function is used to rewrite only a specified region without a sense of incongruity. For modification of a video advertisement, a video generation model (Text-to-Video) or frame interpolation AI is used to perform replacement of a specific scene or automatic change of a telop. Furthermore, when performing multimodal generation combining these (e.g., generating an explanatory text according to an image, or vice versa), a generation process is controlled while evaluating consistency between modalities using a model such as CLIP.

The generation unit can estimate an emotion of a user and adjust a length of the advertising creative to be generated based on the estimated emotion of the user. For example, when the user is in a hurry, the generation unit generates a short advertising creative capturing key points. Also, when the user is relaxed, the generation unit can generate a longer advertising creative including detailed explanation. Furthermore, when the user is excited, the generation unit can generate an advertising creative with visually stimulating effects added. Accordingly, by adjusting the length of the advertising creative according to the emotion of the user, an advertising creative optimal for the user can be generated. Estimation of the emotion is realized using an emotion estimation function using, for example, an emotion engine or a generative AI. The generative AI is, for example, a text generation AI (e.g., LLM) or a multimodal generative AI, but is not limited to such examples. Part or all of the above-described processing in the generation unit may be performed using, for example, AI, or may be performed without using AI. For example, the generation unit can input emotion data of the user to a generative AI and cause the generative AI to execute adjustment of the length of the advertising creative. Specifically, the present generation unit dynamically determines a maximum token number (Max Length) constraint in text generation or a duration (playback time) setting in video generation based on an emotion parameter (time urgency, etc.) of the user. When it is determined that the user is “in a hurry”, the present generation unit gives an instruction to the model to generate a short copy omitting redundant modifiers or a video in a bumper advertisement format of about 6 seconds. Conversely, when the user is in a state of seeking information deeply (relaxed and high interest), a long copy with a story or a long video including detailed function explanation is generated. This adjustment of length is not post-trimming processing for an output of the generation model, but is incorporated as a constraint condition of the generation process itself, so that a natural configuration is maintained.

The generation unit can determine a priority of generation based on a submission time of the advertising creative when performing generation. For example, the generation unit preferentially generates an advertising creative submitted recently. Also, the generation unit can postpone an advertising creative with an old submission time. Furthermore, the generation unit can adjust an order of generation based on the submission time. Accordingly, by determining the priority of generation based on the submission time of the advertising creative, generation can be performed efficiently. Part or all of the above-described processing in the generation unit may be performed using, for example, AI, or may be performed without using AI. For example, the generation unit can input submission time data of the advertising creative to a generative AI and cause the generative AI to execute determination of the priority of generation. Specifically, the present generation unit executes a scheduling algorithm using a waiting time and a processing deadline (Deadline) of each generation task as an evaluation function in a job queue system managing GPU resources. The present generation unit exponentially increases a priority of a task for which a certain period of time has elapsed since submission and a deadline is approaching, thereby preventing SLA (Service Level Agreement) violation. In addition, for a task requiring real-time performance (e.g., live event linked advertisement), it has a function of permitting interrupt processing, suspending (preemption) a low-priority task being executed, and immediately allocating resources.

The generation unit can adjust an order of generation based on a relevance of the advertising creative when performing generation. For example, the generation unit preferentially generates an advertising creative with high relevance. Also, the generation unit can postpone an advertising creative with low relevance. Furthermore, the generation unit can adjust the order of generation based on the relevance of the advertising creative. Accordingly, by adjusting the order of generation based on the relevance of the advertising creative, generation can be performed efficiently. Part or all of the above-described processing in the generation unit may be performed using, for example, AI, or may be performed without using AI. For example, the generation unit can input relevance data of the advertising creative to a generative AI and cause the generative AI to execute adjustment of the order of generation. Specifically, the present generation unit calculates similarity between generation tasks in a vector space, and groups similar tasks (e.g., a task group generating different background colors for the same product image). The present generation unit executes these grouped tasks continuously, thereby performing batch processing optimization that reduces the number of times model weight data is loaded into memory and improves cache efficiency. Also, when a generation result of a certain creative can be reused for generation of another creative (e.g., common background material), a dependency graph is constructed and the order is controlled so that a parent task is executed first, thereby avoiding redundant calculation and improving overall throughput.

The billing unit can estimate an emotion of a user and adjust a timing of billing based on the estimated emotion of the user. For example, when the user feels stress, the billing unit delays the timing of billing to reduce a burden on the user. Also, when the user is relaxed, the billing unit can advance the timing of billing to perform billing efficiently. Furthermore, when the user is in a hurry, the billing unit can optimize the timing of billing to perform billing quickly. Accordingly, by adjusting the timing of billing according to the emotion of the user, the burden on the user can be reduced and billing can be performed efficiently. Estimation of the emotion is realized using an emotion estimation function using, for example, an emotion engine or a generative AI. The generative AI is, for example, a text generation AI (e.g., LLM) or a multimodal generative AI, but is not limited to such examples. Part or all of the above-described processing in the billing unit may be performed using, for example, AI, or may be performed without using AI. For example, the billing unit can input emotion data of the user to a generative AI and cause the generative AI to execute adjustment of the timing of billing. Specifically, the present billing unit implements conditional execution logic triggered by the emotional state of the user in a transaction manager controlling a payment process. When the user shows “high stress” or “frustration” (e.g., immediately after an error screen or when hesitating in operation), the present billing unit temporarily suspends display of a billing confirmation popup or execution of payment processing, and routes it to background processing or postpones it until the end of a session so as not to hinder user experience. Conversely, when a timing at which the user feels “satisfaction” or “sense of achievement” (e.g., immediately after succeeding in high-quality image generation) is detected, a billing offer is immediately presented to perform behavioral economic optimization that increases a conversion rate.

The billing unit can adjust a level of detail of billing based on a usage frequency of the advertising creative when performing billing. For example, the billing unit performs detailed billing for an advertising creative with high usage frequency. Also, the billing unit can perform simplified billing for an advertising creative with low usage frequency. Furthermore, the billing unit can adjust a depth of billing according to the usage frequency of the advertising creative. Accordingly, by adjusting the level of detail of billing based on the usage frequency of the advertising creative, billing can be performed efficiently. Part or all of the above-described processing in the billing unit may be performed using, for example, AI, or may be performed without using AI. For example, the billing unit can input usage frequency data of the advertising creative to a generative AI and cause the generative AI to execute adjustment of the level of detail of billing. Specifically, the present billing unit aggregates access logs of each creative asset and performs tier classification according to usage frequency. For a high-frequency usage (high-tier) asset, pay-per-use or performance-based billing based on detailed metrics such as the number of displays, the number of clicks, and the number of conversions is applied, and calculation is performed in real time and with high accuracy using micropayment technology. On the other hand, for a low-frequency usage (low-tier) asset, a monthly fixed (subscription) or bulk purchase model is applied, and simplified billing processing that reduces transaction costs is performed. This switching is automatically executed by a smart contract and is dynamically applied according to a change in usage status.

The billing unit can apply a different billing algorithm according to a category of the advertising creative when performing billing. For example, when the advertising creative is text-based, the billing unit applies a text billing algorithm. Also, when the advertising creative is image-based, the billing unit can apply an image billing algorithm. Furthermore, when the advertising creative is video-based, the billing unit can apply a video billing algorithm. Accordingly, by applying a different billing algorithm according to the category of the advertising creative, billing can be performed efficiently. Part or all of the above-described processing in the billing unit may be performed using, for example, AI, or may be performed without using AI. For example, the billing unit can input category data of the advertising creative to a generative AI and cause the generative AI to execute application of a different billing algorithm. Specifically, the present billing unit holds a pricing model optimized for each type of content. For text content, a billing algorithm based on the number of tokens, the number of characters, and a uniqueness score of a generated sentence is applied. For image content, a billing algorithm based on resolution, license type (royalty-free or rights-managed), and an amount of calculation resources (GPU time) required for image generation is applied. For video content, a complex billing algorithm combining engagement indicators such as playback time, bit rate, and viewing completion rate is applied. These algorithms also have a function of automatically adjusting unit price parameters based on fluctuation of market prices or output of demand prediction AI.

The billing unit can estimate an emotion of a user and determine a priority of billing based on the estimated emotion of the user. For example, when the user feels stress, the billing unit postpones billing with low importance. Also, when the user is relaxed, the billing unit can preferentially perform billing with high importance. Furthermore, when the user is in a hurry, the billing unit can prioritize an item requiring quick billing. Accordingly, by determining the priority of billing according to the emotion of the user, billing can be performed efficiently. Estimation of the emotion is realized using an emotion estimation function using, for example, an emotion engine or a generative AI. The generative AI is, for example, a text generation AI (e.g., LLM) or a multimodal generative AI, but is not limited to such examples. Part or all of the above-described processing in the billing unit may be performed using, for example, AI, or may be performed without using AI. For example, the billing unit can input emotion data of the user to a generative AI and cause the generative AI to execute determination of the priority of billing. Specifically, the present billing unit has priority control logic that determines a presentation order or a payment processing order when there are a plurality of billing items (monthly usage fee, additional option fee, image purchase fee, etc.). When it is estimated that the user feels “confusion” or “anxiety”, the present billing unit postpones billing of complex option fees, simply presents only basic and essential fees, and prioritizes completion of payment. On the other hand, when the user is in a “favorable” state, a billing item with high added value including a proposal for up-selling or cross-selling is preferentially displayed. This control minimizes a psychological barrier of the user and realizes a smooth payment flow.

The billing unit can determine a priority of billing based on a submission time of the advertising creative when performing billing. For example, the billing unit preferentially bills for an advertising creative submitted recently. Also, the billing unit can postpone an advertising creative with an old submission time. Furthermore, the billing unit can adjust an order of billing based on the submission time. Accordingly, by determining the priority of billing based on the submission time of the advertising creative, billing can be performed efficiently. Part or all of the above-described processing in the billing unit may be performed using, for example, AI, or may be performed without using AI. For example, the billing unit can input submission time data of the advertising creative to a generative AI and cause the generative AI to execute determination of the priority of billing. Specifically, the present billing unit performs sorting processing using data recency as a key in a batch job of billing processing. The present billing unit preferentially aggregates and finalizes billing data regarding a creative used in a most recent campaign, and quickly feeds back cost information to the user. This enables the user to perform budget management of an ongoing project in real time. Also, finalization processing regarding old data is scheduled as off-peak processing in a time zone with low system load, and leveling of calculation resources is achieved.

The billing unit can adjust an order of billing based on a relevance of the advertising creative when performing billing. For example, the billing unit preferentially bills for an advertising creative with high relevance. Also, the billing unit can postpone an advertising creative with low relevance. Furthermore, the billing unit can adjust the order of billing based on the relevance of the advertising creative. Accordingly, by adjusting the order of billing based on the relevance of the advertising creative, billing can be performed efficiently. Part or all of the above-described processing in the billing unit may be performed using, for example, AI, or may be performed without using AI. For example, the billing unit can input relevance data of the advertising creative to a generative AI and cause the generative AI to execute adjustment of the order of billing. Specifically, the present billing unit has a function of grouping billing data of a plurality of creatives belonging to the same project or the same campaign and processing them collectively (batch billing processing). The present billing unit manages relevance between creatives as a graph structure, identifies a strongly connected node group (a group of creatives with high relevance), and performs payment processing as a single transaction. This brings about an effect of reducing transaction costs such as credit card payment fees and blockchain gas fees, and making a statement organized and easy to understand for the user.

The setting unit can estimate an emotion of a user and adjust a setting of the examination criterion based on the estimated emotion of the user. For example, when the user is nervous, the setting unit relaxes the examination criterion. Also, when the user is relaxed, the setting unit can make the examination criterion strict. Furthermore, when the user is in a hurry, the setting unit can optimize the examination criterion. Accordingly, by adjusting the setting of the examination criterion according to the emotion of the user, an appropriate examination criterion can be set. Estimation of the emotion is realized using an emotion estimation function using, for example, an emotion engine or a generative AI. The generative AI is, for example, a text generation AI (e.g., LLM) or a multimodal generative AI, but is not limited to such examples. Part or all of the above-described processing in the setting unit may be performed using, for example, AI, or may be performed without using AI. For example, the setting unit can input emotion data of the user to a generative AI and cause the generative AI to execute setting of the examination criterion. Specifically, the present setting unit analyzes behavior (frequency of setting changes, number of help references, stay time) and biological reactions when the user is operating a setting screen of the system, and determines whether the user feels stress due to complexity of settings. When it is determined that stress is high, the present setting unit hides detailed parameter setting items and automatically switches to a simple mode displaying only preset selections such as “Strict”, “Standard”, and “Relaxed”. At this time, an adaptive setting algorithm operates to finely adjust a specific examination threshold (e.g., allowable error range of image similarity) applied in the background in a direction of reducing a psychological burden on the user (direction of reducing false positives).

The setting unit can set an appropriate criterion based on past examination criterion data when performing setting. For example, the setting unit analyzes past examination criterion data and sets an optimal criterion. Also, the setting unit can adjust the examination criterion based on the past examination criterion data. Furthermore, the setting unit can improve accuracy of the examination criterion by referring to the past examination criterion data. Accordingly, by referring to the past examination criterion data, an optimal examination criterion can be set. Part or all of the above-described processing in the setting unit may be performed using, for example, AI, or may be performed without using AI. For example, the setting unit can input past examination criterion data to a generative AI and cause the generative AI to execute setting of the examination criterion. Specifically, the present setting unit includes a machine learning model that analyzes a correlation between setting values (parameter sets) of examination criteria operated in the past and an examination pass rate, a modification occurrence rate, and user satisfaction (number of complaints, etc.) as a result thereof. The present setting unit uses this model to predict a recommended value (best practice) of the examination criterion most suitable for characteristics (industry, target, media) of the current project, and proposes it to the user as an initial setting. Also, even after the start of operation, actual examination data is taken in as a feedback loop, and parameters are continuously tuned using a method such as Bayesian optimization to continue searching for an optimal solution of the examination criterion.

The setting unit can estimate an emotion of a user and determine a priority of the examination criterion based on the estimated emotion of the user. For example, when the user is nervous, the setting unit postpones an examination criterion with low importance. Also, when the user is relaxed, the setting unit can preferentially set an examination criterion with high importance. Furthermore, when the user is in a hurry, the setting unit can prioritize an examination criterion requiring quick setting. Accordingly, by determining the priority of the examination criterion according to the emotion of the user, the examination criterion can be set efficiently. Estimation of the emotion is realized using an emotion estimation function using, for example, an emotion engine or a generative AI. The generative AI is, for example, a text generation AI (e.g., LLM) or a multimodal generative AI, but is not limited to such examples. Part or all of the above-described processing in the setting unit may be performed using, for example, AI, or may be performed without using AI. For example, the setting unit can input emotion data of the user to a generative AI and cause the generative AI to execute determination of the priority of the examination criterion. Specifically, the present setting unit has a UI control function that dynamically rearranges an order of setting items presented to the user in a setting wizard. When the user is in a “frustrated” state, the present setting unit presents only legally essential minimum setting items (e.g., on/off of copyright check) first, and makes setting of detailed quality criteria (e.g., rules for image brightness and composition) skippable or postpones it. This allows the user to quickly complete the minimum necessary settings without feeling psychological pressure.

The setting unit can perform weighting of the examination criterion based on a submission time of the advertising creative at the time of setting. For example, the setting unit sets a strict examination criterion for a recently submitted advertising creative. Also, the setting unit can relax the examination criterion for an advertising creative with an old submission time. Furthermore, the setting unit can adjust the weighting of the examination criterion based on the submission time. Thereby, by performing weighting of the examination criterion based on the submission time of the advertising creative, the examination criterion can be efficiently set. Part or all of the above-described processing in the setting unit may be performed using, for example, AI, or may be performed without using AI. For example, the setting unit can input submission time data of the advertising creative to generative AI and cause the generative AI to execute the weighting of the examination criterion. Specifically, the present setting unit introduces a “time decay coefficient” or a “trend correction coefficient” considering the obsolescence of the examination criterion over time or the influence of legal amendments. The present setting unit performs weighting reflecting current market trends and the latest laws and regulations for the latest creative to perform a strict check. On the other hand, for past archive data or an old creative to be reused, the present setting unit applies a criterion at that time or lowers a weight of an item whose importance has decreased at present (for example, a check regarding an old design trend), thereby preventing excessive correction indications and saving waste of resources.

The algorithm unit can estimate an emotion of a user and select an algorithm based on the estimated emotion of the user. For example, when the user is relaxed, the algorithm unit selects a detailed algorithm. Also, when the user is in a hurry, the algorithm unit can select a concise algorithm. Furthermore, when the user is excited, the algorithm unit can select a visually stimulating algorithm. Thereby, by selecting the algorithm according to the emotion of the user, an optimal algorithm can be applied. The estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the algorithm unit may be performed using, for example, AI, or may be performed without using AI. For example, the algorithm unit can input emotion data of the user to generative AI and cause the generative AI to execute the selection of the algorithm. Specifically, the present algorithm unit pools a plurality of available AI models (e.g., a highly accurate but slow Transformer model, a fast but low-accuracy lightweight CNN model, a highly creative GAN model, etc.) and includes a Meta-Learning controller that selects an optimal model according to an emotional state of the user. When the user is “in a hurry”, the controller selects a lightweight model with low inference latency and returns a response immediately. When the user is “relaxed” and performing exploratory work, the controller selects a large-scale model that generates diverse and high-quality outputs even if the calculation cost is high. This dynamic model switching optimizes a balance between user experience (UX) and system resources.

The algorithm unit can select an appropriate algorithm based on past algorithm data when executing the algorithm. For example, the algorithm unit analyzes the past algorithm data and selects an optimal algorithm. Also, the algorithm unit can adjust the algorithm based on the past algorithm data. Furthermore, the algorithm unit can improve accuracy of the algorithm with reference to the past algorithm data. Thereby, by referring to the past algorithm data, an optimal algorithm can be selected. Part or all of the above-described processing in the algorithm unit may be performed using, for example, AI, or may be performed without using AI. For example, the algorithm unit can input the past algorithm data to generative AI and cause the generative AI to execute the selection of the algorithm. Specifically, the present algorithm unit refers to a database in which performance (accuracy, speed, convergence) of each algorithm for a past dataset is evaluated and recorded using AutoML (Automated Machine Learning) technology. The present algorithm unit analyzes characteristics (distribution, number of dimensions, sparsity) of newly input data and automatically selects and applies a combination of an algorithm and hyperparameters that exhibited the highest performance with past similar data. This makes it possible to always execute processing optimal for data characteristics without manual tuning.

The algorithm unit can estimate an emotion of a user and adjust an execution frequency of the algorithm based on the estimated emotion of the user. For example, when the user is relaxed, the algorithm unit increases the execution frequency of the algorithm. Also, when the user is in a hurry, the algorithm unit can decrease the execution frequency of the algorithm. Furthermore, when the user is excited, the algorithm unit can adjust the execution frequency of the algorithm. Thereby, by adjusting the execution frequency of the algorithm according to the emotion of the user, the algorithm can be efficiently executed. The estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the algorithm unit may be performed using, for example, AI, or may be performed without using AI. For example, the algorithm unit can input emotion data of the user to generative AI and cause the generative AI to execute the adjustment of the execution frequency of the algorithm. Specifically, the present algorithm unit controls a polling interval or a trigger condition of an inference process (e.g., real-time proofreading or suggestion generation) operating in the background. When the user is working in a “concentrated” or “relaxed” state, the present algorithm unit increases the execution frequency (e.g., for every keystroke) and provides feedback in real time. On the other hand, when the user is in a “confused” or “frustrated” state, the present algorithm unit decreases the execution frequency (e.g., only at the time of sentence end input) to prevent frequent screen updates or pop-ups from becoming a further stress factor, thereby controlling so as not to disturb the user's thinking.

The algorithm unit can perform weighting of the algorithm based on a submission time of the advertising creative when executing the algorithm. For example, the algorithm unit applies a strict algorithm to a recently submitted advertising creative. Also, the algorithm unit can relax the algorithm for an advertising creative with an old submission time. Furthermore, the algorithm unit can adjust the weighting of the algorithm based on the submission time. Thereby, by performing weighting of the algorithm based on the submission time of the advertising creative, the algorithm can be efficiently executed. Part or all of the above-described processing in the algorithm unit may be performed using, for example, AI, or may be performed without using AI. For example, the algorithm unit can input submission time data of the advertising creative to generative AI and cause the generative AI to execute the weighting of the algorithm. Specifically, the present algorithm unit dynamically changes a weight coefficient for an output of each model according to freshness of data (Time Decay) in ensemble learning. For the latest creative, the present algorithm unit increases a weight of a model that has learned the latest trend or regulation, and for an old creative, maintains a weight of a baseline model operating stably for a long period of time. This enables algorithm execution that flexibly responds to evaluation criteria that change with the passage of time.

The management unit can estimate an emotion of a user and adjust a collection method of images based on the estimated emotion of the user. For example, when the user feels stress, the management unit simplifies the collection method. Also, when the user is relaxed, the management unit can provide a detailed collection method. Furthermore, when the user is in a hurry, the management unit can provide a rapid collection method. Thereby, by adjusting the collection method of images according to the emotion of the user, images can be efficiently collected. The estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the management unit may be performed using, for example, AI, or may be performed without using AI. For example, the management unit can input emotion data of the user to generative AI and cause the generative AI to execute the adjustment of the collection method of images. Specifically, the present management unit controls an interface for performing search query generation or filtering condition setting for image collection. When the user feels “stress”, the present management unit hides complex detailed search options and provides a simple mode executable with one click, such as “automatic collection”. Also, the present management unit instructs a backend crawler to prioritize response speed over comprehensiveness, and changes operation so as to set a search depth (Search Depth) shallow and return a result quickly.

The management unit can select an appropriate collection method based on past collection data when managing the collection method. For example, the management unit analyzes the past collection data and selects an optimal collection method. Also, the management unit can adjust the collection method based on the past collection data. Furthermore, the management unit can improve accuracy of the collection method with reference to the past collection data. Thereby, by referring to the past collection data, an optimal collection method can be selected. Part or all of the above-described processing in the management unit may be performed using, for example, AI, or may be performed without using AI. For example, the management unit can input the past collection data to generative AI and cause the generative AI to execute the selection of the collection method. Specifically, the present management unit analyzes log data such as a success rate, quality of acquired data, and required time in a past collection task, and calculates a reliability score for each collection source (Web site, API, SNS, etc.). The present management unit executes a routing algorithm that preferentially selects a source with a high possibility of obtaining the most efficient and high-quality image based on this score. Also, the present management unit has a function of learning a pattern blocked or subjected to access restriction in the past and automatically adjusting and avoiding an access interval of crawling or User-Agent setting.

The management unit can estimate an emotion of a user and determine a priority of the collection method based on the estimated emotion of the user. For example, when the user feels stress, the management unit postpones a collection method with low importance. Also, when the user is relaxed, the management unit can preferentially perform a collection method with high importance. Furthermore, when the user is in a hurry, the management unit can prioritize an item requiring rapid collection. Thereby, by determining the priority of the collection method according to the emotion of the user, images can be efficiently collected. The estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the management unit may be performed using, for example, AI, or may be performed without using AI. For example, the management unit can input emotion data of the user to generative AI and cause the generative AI to execute the determination of the priority of the collection method. Specifically, the present management unit manages task queues of a plurality of collection agents (crawlers), and dynamically swaps priorities of the queues according to an emotional state of the user. When the user is in a “frustrated” state, the present management unit gives top priority to a collection task via an API from an immediately available stock photo site, and postpones a Web scraping task that takes time. Thereby, system resources are allocated in a form responding to “immediacy” required by the user.

The management unit can perform weighting of the collection method based on a submission time of the advertising creative when managing the collection method. For example, the management unit applies a strict collection method to a recently submitted advertising creative. Also, the management unit can relax the collection method for an advertising creative with an old submission time. Furthermore, the management unit can adjust the weighting of the collection method based on the submission time. Thereby, by performing weighting of the collection method based on the submission time of the advertising creative, images can be efficiently collected. Part or all of the above-described processing in the management unit may be performed using, for example, AI, or may be performed without using AI. For example, the management unit can input submission time data of the advertising creative to generative AI and cause the generative AI to execute the weighting of the collection method. Specifically, the present management unit evaluates metadata (creation date, update date) of an image to be collected, and determines a collection frequency or strictness of a check based on freshness of information. In image collection for a new campaign that needs to reflect the latest trend, the present management unit cross-checks a plurality of sources and performs weighting to carefully select a high-resolution image with clear rights relations. On the other hand, in collection for the purpose of past archiving, the present management unit relaxes requirements for image quality or completeness of metadata and applies a lightweight collection mode that saves storage capacity and bandwidth.

The system unit can estimate an emotion of a user and adjust a setting of the billing system based on the estimated emotion of the user. For example, when the user feels stress, the system unit relaxes the setting of the billing system. Also, when the user is relaxed, the system unit can make the setting of the billing system strict. Furthermore, when the user is in a hurry, the system unit can optimize the setting of the billing system. Thereby, by adjusting the setting of the billing system according to the emotion of the user, billing can be efficiently performed. The estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the system unit may be performed using, for example, AI, or may be performed without using AI. For example, the system unit can input emotion data of the user to generative AI and cause the generative AI to execute the adjustment of the setting of the billing system. Specifically, the present system unit adopts risk-based authentication logic that varies a security level in billing authentication (such as a request frequency of multi-factor authentication) or a setting of session timeout according to an emotional state of the user. When it is detected that the user is “irritated” (stress is high), the present system unit applies a setting that reduces the user's trouble (friction) by skipping a request for re-authentication or strengthening auto-completion of an input form within a range where security risk is determined to be low.

The system unit can perform an appropriate billing setting based on past billing data when managing the billing system. For example, the system unit analyzes the past billing data and performs an optimal billing setting. Also, the system unit can adjust the billing setting based on the past billing data. Furthermore, the system unit can improve accuracy of the billing setting with reference to the past billing data. Thereby, by referring to the past billing data, an optimal billing setting can be performed. Part or all of the above-described processing in the system unit may be performed using, for example, AI, or may be performed without using AI. For example, the system unit can input the past billing data to generative AI and cause the generative AI to execute the adjustment of the billing setting. Specifically, the present system unit analyzes financial data such as a past transaction history, an unpaid occurrence rate, and a chargeback rate, and calculates a credit score (Credit Score) for each user. The present system unit automatically optimizes a setting of a credit limit (Credit Limit) or a payment cycle (immediate payment or month-end closing) based on this credit score. Also, the present system unit statistically sets a threshold for detecting an abnormal billing pattern (such as a sudden increase in usage) based on a past data distribution, leading to early detection of unauthorized use.

The system unit can estimate an emotion of a user and determine a priority of the billing system based on the estimated emotion of the user. For example, when the user feels stress, the system unit postpones a billing setting with low importance. Also, when the user is relaxed, the system unit can preferentially perform a billing setting with high importance. Furthermore, when the user is in a hurry, the system unit can prioritize a billing item requiring rapid setting. Thereby, by determining the priority of the billing system according to the emotion of the user, billing can be efficiently performed. The estimation of the emotion is realized using an emotion estimation function using, for example, an emotion engine or generative AI. The generative AI is, for example, text generative AI (e.g., LLM) or multimodal generative AI, but is not limited to such examples. Part or all of the above-described processing in the system unit may be performed using, for example, AI, or may be performed without using AI. For example, the system unit can input emotion data of the user to generative AI and cause the generative AI to execute the determination of the priority of the billing system. Specifically, the present system unit controls an order of notification to the user or input request in a management task such as account setting or registration of a payment method. When the user is in a “high load” state, the present system unit suppresses a prompt for a setting that is not essential for continuous use of the service (for example, change of addressee of receipt or notification mail setting) so as not to hinder use of a core function. Conversely, the present system unit schedules to display a reminder prompting input of an unset item when the user is in a state with allowance.

The system unit can perform weighting of the billing setting based on a submission time of the advertising creative when managing the billing system. For example, the system unit applies a strict billing setting to a recently submitted advertising creative. Also, the system unit can relax the billing setting for an advertising creative with an old submission time. Furthermore, the system unit can adjust the weighting of the billing setting based on the submission time. Thereby, by performing weighting of the billing setting based on the submission time of the advertising creative, billing can be efficiently performed. Part or all of the above-described processing in the system unit may be performed using, for example, AI, or may be performed without using AI. For example, the system unit can input submission time data of the advertising creative to generative AI and cause the generative AI to execute the weighting of the billing setting. Specifically, the present system unit has a lifecycle management function reflecting data storage cost and management cost. For a newly submitted creative, the present system unit places it in storage accessible at high speed and applies a billing rate reflecting the cost. On the other hand, for an old creative for which a certain period has elapsed, the present system unit automatically moves it to inexpensive cold storage (archive) and performs weighting to reduce the billing setting (storage fee) accordingly. This tiering processing realizes optimization of cost efficiency of the entire system and a billing amount to the user.

The system according to the embodiment is not limited to the above-described examples, and various modifications are possible, for example, as follows. Specifically, the present system can adopt not only a centralized server configuration but also an edge AI configuration in which a part of an inference model is distributed and arranged in an edge computing device (smartphone, tablet, IoT camera, etc.). Also, each module (collection, analysis, examination, generation, billing) may be implemented as an independent microservice and configured to be dynamically scaled on a container orchestration system such as Kubernetes. Furthermore, in learning of an AI model, it is also possible to apply a privacy-preserving learning method that uses Federated Learning technology and aggregates only model updates to a server to improve a global model without taking out privacy data of a user from each device.

The collection unit can estimate an emotion of a user and adjust a type of the advertising creative to be collected based on the estimated emotion of the user. For example, when the user feels stress, the collection unit preferentially collects an advertising creative with a relaxing effect. Also, when the user is excited, the collection unit can collect a visually stimulating advertising creative. Furthermore, when the user is relaxed, the collection unit can collect an advertising creative including detailed information. Thereby, by adjusting the type of the advertising creative to be collected according to the emotion of the user, an advertising creative optimal for the user can be provided. The estimation of the emotion is realized using an emotion estimation function using, for example, an emotion engine or generative AI. The generative AI is, for example, text generative AI (e.g., LLM) or multimodal generative AI, but is not limited to such examples. Specifically, the present collection unit analyzes visual features (hue, saturation, brightness, frequency component) of an image or a moving image and includes a sensitivity evaluation model that scores a psychological effect (sedative effect, arousal effect, etc.) given to a human. The present collection unit searches for and collects a creative having a vector in a direction opposite to an emotion vector (current state) of the user (for example, an image of low arousal and high pleasure at the time of high stress), thereby forming a feedback loop that guides the emotion of the user to a neutral or positive state.

The analysis unit can estimate an emotion of a user and adjust a depth of analysis based on the estimated emotion when analyzing content of the advertising creative. For example, when the user is in a hurry, the analysis unit provides a concise analysis result. Also, when the user is relaxed, the analysis unit can provide a detailed analysis result. Furthermore, when the user is excited, the analysis unit can provide a visually stimulating analysis result. Thereby, by adjusting the depth of analysis according to the emotion of the user, an analysis result easy for the user to understand can be provided. The estimation of the emotion is realized using an emotion estimation function using, for example, an emotion engine or generative AI. The generative AI is, for example, text generative AI (e.g., LLM) or multimodal generative AI, but is not limited to such examples. Specifically, the present analysis unit uses a hierarchical summarization model that controls an abstraction level of information in an output layer of the analysis result. When it is estimated that the user has no “time allowance”, the present analysis unit outputs the highest abstraction layer (e.g., only OK/NG determination). When there is allowance, the present analysis unit expands and outputs up to a lower layer (e.g., a score of each element, a similar case, a ground for an improvement proposal). This control is technically implemented by mask processing in an attention mechanism or a depth limit of a decision tree.

The examination unit can estimate an emotion of a user and adjust strictness of examination based on the estimated emotion when examining the advertising creative. For example, when the user is nervous, the examination unit relaxes an examination criterion. Also, when the user is relaxed, the examination unit can make the examination criterion strict. Furthermore, when the user is in a hurry, the examination unit can optimize the examination criterion. Thereby, by adjusting the strictness of examination according to the emotion of the user, appropriate examination can be performed. The estimation of the emotion is realized using an emotion estimation function using, for example, an emotion engine or generative AI. The generative AI is, for example, text generative AI (e.g., LLM) or multimodal generative AI, but is not limited to such examples. Specifically, the present examination unit adopts a determination system using Fuzzy Logic, and can continuously change a boundary value of determination from “Strict” to “Lenient”. The present examination unit dynamically transforms a membership function using an emotion score (stress level) of the user as an input variable, and performs bias control such that determination of a creative in a gray zone is tilted to a “pass” side at the time of stress and to a “confirmation required” side at the time of relaxation.

The generation unit can estimate an emotion of a user and adjust a tone of the advertising creative to be generated based on the estimated emotion when generating the advertising creative. For example, when the user is relaxed, the generation unit generates an advertising creative with a soft tone. Also, when the user is in a hurry, the generation unit can generate an advertising creative with a concise tone. Furthermore, when the user is excited, the generation unit can generate an advertising creative with a visually stimulating tone. Thereby, by adjusting the tone of the advertising creative according to the emotion of the user, an advertising creative optimal for the user can be generated. The estimation of the emotion is realized using an emotion estimation function using, for example, an emotion engine or generative AI. The generative AI is, for example, text generative AI (e.g., LLM) or multimodal generative AI, but is not limited to such examples. Specifically, the present generation unit performs Style Transfer technology or style vector manipulation in a latent space of a generative model (GAN/Diffusion). A style vector corresponding to an emotional state of the user (for example, “soft”=low contrast/warm color system) is learned or defined in advance, and by injecting (Injection) this into a generation process, only a visual/linguistic tone is modulated according to the emotion of the user while maintaining semantic content of content.

The billing unit can estimate an emotion of a user and adjust a timing of billing based on the estimated emotion. For example, when the user feels stress, the billing unit delays the timing of billing to reduce a burden on the user. Also, when the user is relaxed, the billing unit can advance the timing of billing to efficiently perform billing. Furthermore, when the user is in a hurry, the billing unit can optimize the timing of billing to rapidly perform billing. Thereby, by adjusting the timing of billing according to the emotion of the user, the burden on the user is reduced, and billing can be efficiently performed. The estimation of the emotion is realized using an emotion estimation function using, for example, an emotion engine or generative AI. The generative AI is, for example, text generative AI (e.g., LLM) or multimodal generative AI, but is not limited to such examples. Specifically, the present billing unit functions as an intelligent agent that manages interruption (Interruption) to an operation flow of the user. The agent evaluates an emotional state of the user and importance of a current task, and calculates a cost (Cognitive Cost) that start of a billing process hinders a workflow of the user. The agent triggers billing processing at a timing when this cost falls below a predetermined threshold (for example, break time at the time of task completion).

The collection unit can analyze a past advertising creative submission history of a user and select an appropriate collection method when collecting the advertising creative. For example, the collection unit analyzes a tendency of the advertising creative submitted by the user in the past and proposes an optimal collection method. Also, the collection unit can perform collection in a specific time zone from the past submission history of the user. Furthermore, the collection unit can customize the collection method based on the past submission history of the user. Thereby, by analyzing the past submission history, an optimal collection method can be proposed, and collection can be efficiently performed. Specifically, the present collection unit learns periodicity of an activity pattern (day of the week, time zone, file format, data amount) of the user using a time-series data analysis model (LSTM or Transformer). Based on this learning model, the present collection unit predicts a future data submission event, and performs predictive resource management such as securing (pre-warming) resources of a serverless computing infrastructure (AWS Lambda, etc.) just in time or reserving a network bandwidth.

The analysis unit can apply a different analysis algorithm according to a category of the advertising creative when analyzing the advertising creative. For example, when the advertising creative is text-based, a natural language processing algorithm is applied. Also, when the advertising creative is image-based, an image analysis algorithm can be applied. Furthermore, when the advertising creative is video-based, a video analysis algorithm can be applied. Thereby, by applying a different analysis algorithm according to the category of the advertising creative, accuracy of analysis improves. Specifically, the present analysis unit is composed of a common encoder configured to project input data into a multimodal embedding space, and a Mixture of Experts (MoE) model specialized for each modality (text, image, video). A gate network selects and weights an optimal expert model according to characteristics of the input data, and integrates outputs thereof, thereby realizing high-precision and robust analysis that cannot be achieved by a single model.

The examination unit can improve accuracy of examination based on an interrelationship of advertising creatives when examining the advertising creative. For example, the examination unit analyzes relevance between advertising creatives to improve the accuracy of examination. Also, the examination unit can adjust an examination result in consideration of the interrelationship of the advertising creatives. Furthermore, the examination unit can improve the accuracy of examination based on the interrelationship of the advertising creatives. Thereby, by considering the interrelationship of the advertising creatives, the accuracy of examination improves. Specifically, the present examination unit constructs a Knowledge Graph, represents creatives, products, brands, legal regulations, past examination cases, and the like as nodes, and defines relationships thereof as edges. Inference on this graph is performed using a Graph Neural Network (GNN) to detect not only direct violations but also indirect risks (for example, inappropriate associations due to specific combinations) that are revealed by tracing relationships.

The generation unit can apply a different generation algorithm according to a category of the advertising creative when generating the advertising creative. For example, when the advertising creative is text-based, a natural language generation algorithm is applied. Also, when the advertising creative is image-based, an image generation algorithm can be applied. Furthermore, when the advertising creative is video-based, a video generation algorithm can be applied. Thereby, by applying a different generation algorithm according to the category of the advertising creative, accuracy of generation improves. Specifically, the present generation unit holds generation models (LLM, Diffusion, GAN, VAE, etc.) specialized for respective categories as microservices, and an orchestrator calls an appropriate service according to an input request. Furthermore, the generation unit automatically constructs pipeline processing (Chaining) that chains different algorithms, such as generating an image from text and generating a video from the image, thereby enabling consistent generation of multimedia content.

The billing unit can adjust a level of detail of billing based on a usage frequency of the advertising creative when billing for the advertising creative. For example, for an advertising creative with high usage frequency, detailed billing is performed. Also, for an advertising creative with low usage frequency, simplified billing can be performed. Furthermore, the billing unit can adjust a depth of billing according to the usage frequency of the advertising creative. Thereby, by adjusting the level of detail of billing based on the usage frequency of the advertising creative, billing can be performed efficiently. Specifically, the present billing unit analyzes usage frequency data in real time with a stream processing engine (Apache Kafka, Flink, etc.) and dynamically switches a billing policy. At the time of high-frequency usage, a detailed log is recorded for each event and complex discount logic or tiered pricing is applied, while at the time of low-frequency usage, logs are sampled or aggregated (Aggregation) and recorded, and an adaptive logging mechanism that reduces storage cost and processing load is provided.

A flow of processing of Example of the Embodiment will be briefly described below. Specifically, this processing flow is configured as pipeline processing realized not only by executing each step synchronously but also by an asynchronous event-driven architecture via a message queue. Thereby, parallel execution and scalability of each process are secured.

Step 1: The collection unit collects content of an advertising creative. The collection unit can receive an upload from a user or provision from a partner, and can also collect an advertising creative on the Internet using web scraping technology.

Step 2: The analysis unit analyzes the content of the advertising creative collected by the collection unit and performs examination based on an examination criterion. The analysis unit analyzes text, image, and audio content of the advertising creative using natural language processing technology, image recognition technology, and voice recognition technology.

Step 3: The examination unit outputs an examination result based on the content analyzed by the analysis unit. The examination unit checks whether the advertising creative is legally problematic, whether it infringes copyright, whether an appropriate representation is used, and the like, and evaluates it based on the examination criterion.

Step 4: The generation unit automatically generates an improvement of the advertising creative based on the examination result output by the examination unit. The generation unit replaces a legally problematic representation with an appropriate representation, or replaces an image infringing copyright with a free image. The generation unit automatically generates content of the advertising creative using natural language generation technology, image generation technology, and voice generation technology.

Step 5: The billing unit collects rights-processed images or free images and performs billing according to usage frequency or a situation. The billing unit provides an image to be used for the advertising creative at an appropriate price according to the usage frequency or the situation, and allows a user to search for and download the image. Specifically, in Step 1, the collection unit acquires data in multi-threads using a distributed crawler, saves raw data in a data lake (S3, etc.), and simultaneously indexes metadata in a NoSQL database. In Step 2, the analysis unit distributes tasks to an inference server group on a GPU cluster, and performs feature extraction and semantic analysis in parallel using a deep learning model. In Step 3, the examination unit performs matching between an extracted feature vector and a reference vector of a legal regulation database, and calculates a violation probability score. In Step 4, the generation unit performs local correction (inpainting) or rewriting of text on a region having a high violation score using a Generative Adversarial Network (GAN) or a diffusion model, and generates a correction candidate. In Step 5, the billing unit executes a smart contract on a blockchain, and completes granting of usage authority for the generated corrected creative and micropayment settlement therefor as an atomic transaction.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of a plurality of elements including the above-described collection unit, analysis unit, examination unit, generation unit, and billing unit is implemented by, for example, at least one of a smart device 14 and a data processing apparatus 12. For example, the collection unit is implemented by a control unit 46A of the smart device 14, and can receive an upload from a user or provision from a partner. The analysis unit is implemented by, for example, a specific processing unit 290 of the data processing apparatus 12, and analyzes the content of the advertising creative using natural language processing technology or image recognition technology. The examination unit is implemented by, for example, the specific processing unit 290 of the data processing apparatus 12, and evaluates the content of the advertising creative based on the examination criterion. The generation unit is implemented by, for example, the specific processing unit 290 of the data processing apparatus 12, and automatically generates an improvement of the advertising creative based on the examination result. The billing unit is implemented by, for example, the control unit 46A of the smart device 14, and collects rights-processed images or free images and performs billing according to usage frequency or a situation. The correspondence relationship between each unit and the apparatus or the control unit is not limited to the above-described example, and various modifications are possible.

### Second Embodiment

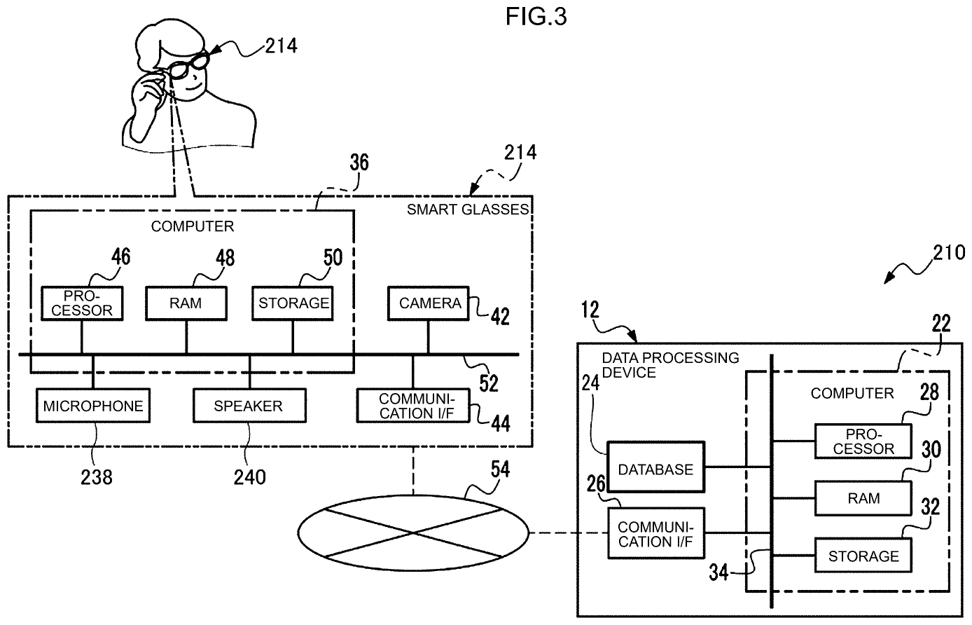

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

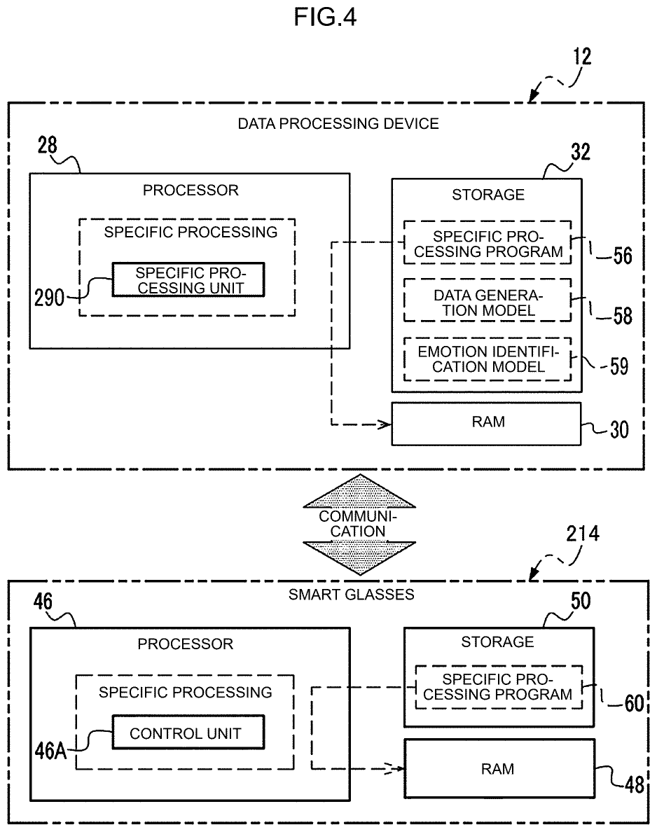

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of a plurality of elements including the above-described collection unit, analysis unit, examination unit, generation unit, and billing unit is implemented by, for example, at least one of smart glasses 214 and the data processing apparatus 12. For example, the collection unit is implemented by a control unit 46A of the smart glasses 214, and can receive an upload from a user or provision from a partner. The analysis unit is implemented by, for example, a specific processing unit 290 of the data processing apparatus 12, and analyzes the content of the advertising creative using natural language processing technology or image recognition technology. The examination unit is implemented by, for example, the specific processing unit 290 of the data processing apparatus 12, and evaluates the content of the advertising creative based on the examination criterion. The generation unit is implemented by, for example, the specific processing unit 290 of the data processing apparatus 12, and automatically generates an improvement of the advertising creative based on the examination result. The billing unit is implemented by, for example, the control unit 46A of the smart glasses 214, and collects rights-processed images or free images and performs billing according to usage frequency or a situation. The correspondence relationship between each unit and the apparatus or the control unit is not limited to the above-described example, and various modifications are possible.

### Third Embodiment

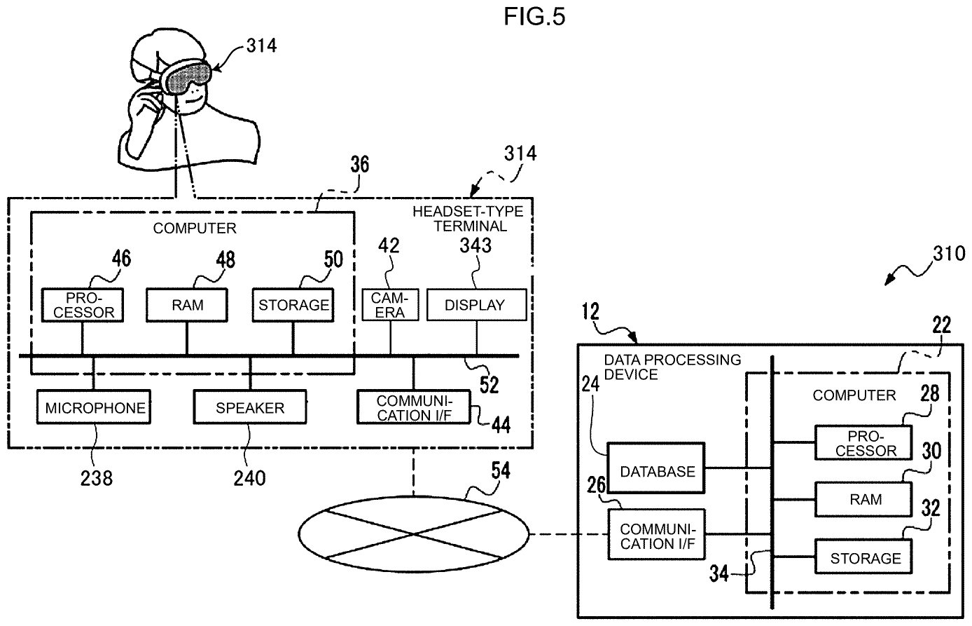

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

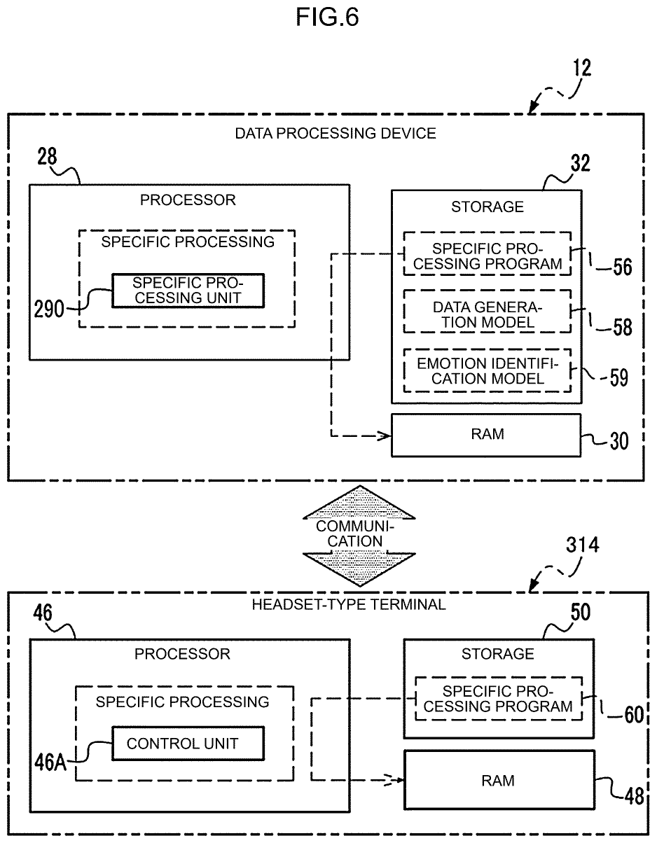

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of a plurality of elements including the above-described collection unit, analysis unit, examination unit, generation unit, and billing unit is implemented by, for example, at least one of a headset-type terminal 314 and the data processing apparatus 12. For example, the collection unit is implemented by a control unit 46A of the headset-type terminal 314, and can receive an upload from a user or provision from a partner. The analysis unit is implemented by, for example, a specific processing unit 290 of the data processing apparatus 12, and analyzes the content of the advertising creative using natural language processing technology or image recognition technology. The examination unit is implemented by, for example, the specific processing unit 290 of the data processing apparatus 12, and evaluates the content of the advertising creative based on the examination criterion. The generation unit is implemented by, for example, the specific processing unit 290 of the data processing apparatus 12, and automatically generates an improvement of the advertising creative based on the examination result. The billing unit is implemented by, for example, the control unit 46A of the headset-type terminal 314, and collects rights-processed images or free images and performs billing according to usage frequency or a situation. The correspondence relationship between each unit and the apparatus or the control unit is not limited to the above-described example, and various modifications are possible.

### Fourth Embodiment

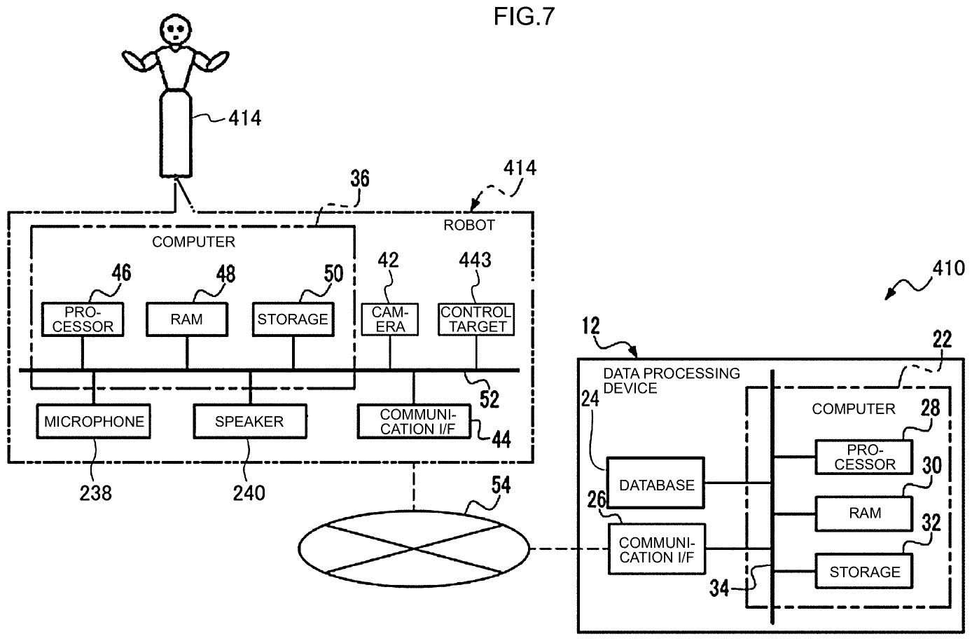

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

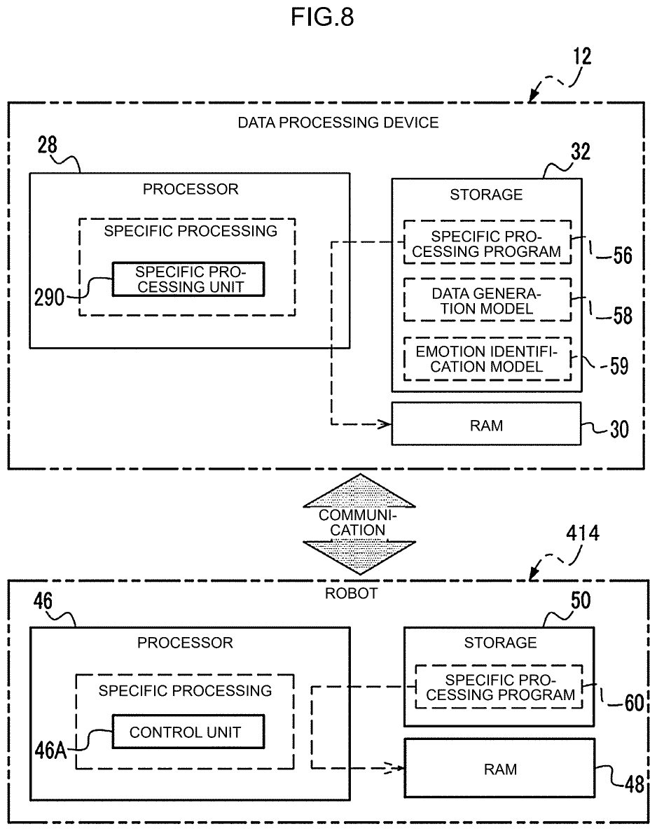

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of a plurality of elements including the above-described collection unit, analysis unit, examination unit, generation unit, and billing unit is implemented by, for example, at least one of a robot 414 and the data processing apparatus 12. For example, the collection unit is implemented by a control unit 46A of the robot 414, and can receive an upload from a user or provision from a partner. The analysis unit is implemented by, for example, a specific processing unit 290 of the data processing apparatus 12, and analyzes the content of the advertising creative using natural language processing technology or image recognition technology. The examination unit is implemented by, for example, the specific processing unit 290 of the data processing apparatus 12, and evaluates the content of the advertising creative based on the examination criterion. The generation unit is implemented by, for example, the specific processing unit 290 of the data processing apparatus 12, and automatically generates an improvement of the advertising creative based on the examination result. The billing unit is implemented by, for example, the control unit 46A of the robot 414, and collects rights-processed images or free images and performs billing according to usage frequency or a situation. The correspondence relationship between each unit and the apparatus or the control unit is not limited to the above-described example, and various modifications are possible.

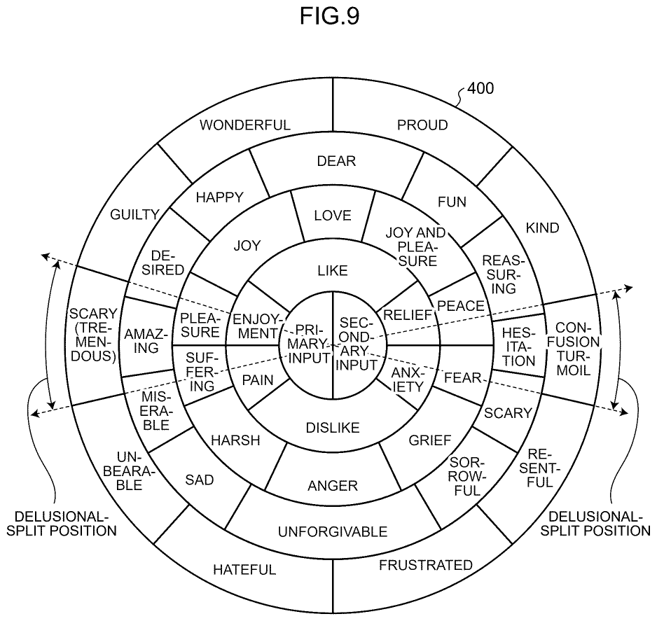

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

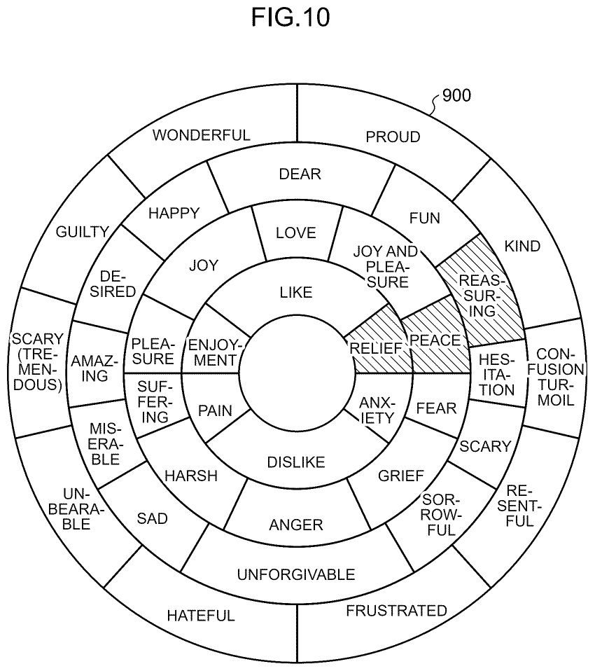

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a collection unit configured to collect content of an advertising creative; an analysis unit configured to analyze the content collected by the collection unit and perform examination based on an examination criterion; an examination unit configured to output an examination result based on the content analyzed by the analysis unit; a generation unit configured to automatically generate an improvement of the advertising creative based on the examination result output by the examination unit; and a billing unit configured to collect rights-processed images or free images and perform billing according to usage frequency or a situation.
(Supplementary Note 2)The system according to Supplementary Note 1, further comprising a setting unit configured to set the examination criterion.
(Supplementary Note 3)The system according to Supplementary Note 1, further comprising an algorithm unit configured to execute an automatic generation algorithm for the improvement.
(Supplementary Note 4)The system according to Supplementary Note 1, further comprising a management unit configured to manage a collection method of images.
(Supplementary Note 5)The system according to Supplementary Note 1, further comprising a system unit configured to manage a billing system.
(Supplementary Note 6)The system according to Supplementary Note 1, wherein the collection unit is configured to estimate an emotion of a user and adjust a collection timing of the advertising creative based on the estimated emotion of the user.
(Supplementary Note 7)The system according to Supplementary Note 1, wherein the collection unit is configured to analyze a past advertising creative submission history of a user and select an appropriate collection method.
(Supplementary Note 8)The system according to Supplementary Note 1, wherein the collection unit is configured to perform filtering based on a current project or a field of interest of a user when collecting the advertising creative.
(Supplementary Note 9)The system according to Supplementary Note 1, wherein the collection unit is configured to estimate an emotion of a user and determine a priority of the advertising creative to be collected based on the estimated emotion of the user.
(Supplementary Note 10)The system according to Supplementary Note 1, wherein the collection unit is configured to preferentially collect highly relevant creatives based on geographical location information of a user when collecting the advertising creative.
(Supplementary Note 11)The system according to Supplementary Note 1, wherein the collection unit is configured to analyze social media activity of a user and collect a relevant creative when collecting the advertising creative.
(Supplementary Note 12)The system according to Supplementary Note 1, wherein the analysis unit is configured to estimate an emotion of a user and adjust a representation method of analysis based on the estimated emotion of the user.
(Supplementary Note 13)The system according to Supplementary Note 1, wherein the analysis unit is configured to adjust a level of detail of analysis based on an importance of the advertising creative when performing analysis.
(Supplementary Note 14)The system according to Supplementary Note 1, wherein the analysis unit is configured to apply a different analysis algorithm according to a category of the advertising creative when performing analysis.
(Supplementary Note 15)The system according to Supplementary Note 1, wherein the analysis unit is configured to estimate an emotion of a user and adjust a length of analysis based on the estimated emotion of the user.
(Supplementary Note 16)The system according to Supplementary Note 1, wherein the analysis unit is configured to determine a priority of analysis based on a submission time of the advertising creative when performing analysis.
(Supplementary Note 17)The system according to Supplementary Note 1, wherein the analysis unit is configured to adjust an order of analysis based on a relevance of the advertising creative when performing analysis.
(Supplementary Note 18)The system according to Supplementary Note 1, wherein the examination unit is configured to estimate an emotion of a user and adjust a criterion for examination based on the estimated emotion of the user.
(Supplementary Note 19)The system according to Supplementary Note 1, wherein the examination unit is configured to improve accuracy of examination based on an interrelationship of advertising creatives when performing examination.
(Supplementary Note 20)The system according to Supplementary Note 1, wherein the examination unit is configured to perform examination in consideration of attribute information of a submitter of the advertising creative when performing examination.
(Supplementary Note 21)The system according to Supplementary Note 1, wherein the examination unit is configured to estimate an emotion of a user and adjust an order of displaying a result of examination based on the estimated emotion of the user.
(Supplementary Note 22)The system according to Supplementary Note 1, wherein the examination unit is configured to perform examination based on a geographical distribution of advertising creatives when performing examination.
(Supplementary Note 23)The system according to Supplementary Note 1, wherein the examination unit is configured to refer to related literature of the advertising creative to improve accuracy of examination when performing examination.
(Supplementary Note 24)The system according to Supplementary Note 1, wherein the generation unit is configured to estimate an emotion of a user and adjust a representation method of the advertising creative to be generated based on the estimated emotion of the user.
(Supplementary Note 25)The system according to Supplementary Note 1, wherein the generation unit is configured to adjust a level of detail of generation based on an importance of the advertising creative when performing generation.
(Supplementary Note 26)The system according to Supplementary Note 1, wherein the generation unit is configured to apply a different generation algorithm according to a category of the advertising creative when performing generation.
(Supplementary Note 27)The system according to Supplementary Note 1, wherein the generation unit is configured to estimate an emotion of a user and adjust a length of the advertising creative to be generated based on the estimated emotion of the user.
(Supplementary Note 28)The system according to Supplementary Note 1, wherein the generation unit is configured to determine a priority of generation based on a submission time of the advertising creative when performing generation.
(Supplementary Note 29)The system according to Supplementary Note 1, wherein the generation unit is configured to adjust an order of generation based on a relevance of the advertising creative when performing generation.
(Supplementary Note 30)The system according to Supplementary Note 1, wherein the billing unit is configured to estimate an emotion of a user and adjust a timing of billing based on the estimated emotion of the user.
(Supplementary Note 31)The system according to Supplementary Note 1, wherein the billing unit is configured to adjust a level of detail of billing based on a usage frequency of the advertising creative when performing billing.
(Supplementary Note 32)The system according to Supplementary Note 1, wherein the billing unit is configured to apply a different billing algorithm according to a category of the advertising creative when performing billing.
(Supplementary Note 33)The system according to Supplementary Note 1, wherein the billing unit is configured to estimate an emotion of a user and determine a priority of billing based on the estimated emotion of the user.
(Supplementary Note 34)The system according to Supplementary Note 1, wherein the billing unit is configured to determine a priority of billing based on a submission time of the advertising creative when performing billing.
(Supplementary Note 35)The system according to Supplementary Note 1, wherein the billing unit is configured to adjust an order of billing based on a relevance of the advertising creative when performing billing.
(Supplementary Note 36)The system according to Supplementary Note 1, wherein the setting unit is configured to estimate an emotion of a user and adjust a setting of the examination criterion based on the estimated emotion of the user.
(Supplementary Note 37)The system according to Supplementary Note 1, wherein the setting unit is configured to set an appropriate criterion based on past examination criterion data when performing setting.
(Supplementary Note 38)The system according to Supplementary Note 1, wherein the setting unit is configured to estimate an emotion of a user and determine a priority of the examination criterion based on the estimated emotion of the user.
(Supplementary Note 39)The system according to Supplementary Note 1, wherein the setting unit is configured to perform weighting of the examination criterion based on a submission time of the advertising creative when performing setting.
(Supplementary Note 40)The system according to Supplementary Note 1, wherein the algorithm unit is configured to estimate an emotion of a user and select an algorithm based on the estimated emotion of the user.
(Supplementary Note 41)The system according to Supplementary Note 1, wherein the algorithm unit is configured to select an appropriate algorithm based on past algorithm data when executing the algorithm.
(Supplementary Note 42)The system according to Supplementary Note 1, wherein the algorithm unit is configured to estimate an emotion of a user and adjust an execution frequency of the algorithm based on the estimated emotion of the user.
(Supplementary Note 43)The system according to Supplementary Note 1, wherein the algorithm unit is configured to perform weighting of the algorithm based on a submission time of the advertising creative when executing the algorithm.
(Supplementary Note 44)The system according to Supplementary Note 1, wherein the management unit is configured to estimate an emotion of a user and adjust the collection method of images based on the estimated emotion of the user.
(Supplementary Note 45)The system according to Supplementary Note 1, wherein the management unit is configured to select an appropriate collection method based on past collection data when managing the collection method.
(Supplementary Note 46)The system according to Supplementary Note 1, wherein the management unit is configured to estimate an emotion of a user and determine a priority of the collection method based on the estimated emotion of the user.
(Supplementary Note 47)The system according to Supplementary Note 1, wherein the management unit is configured to perform weighting of the collection method based on a submission time of the advertising creative when managing the collection method.
(Supplementary Note 48)The system according to Supplementary Note 1, wherein the system unit is configured to estimate an emotion of a user and adjust a setting of the billing system based on the estimated emotion of the user.
(Supplementary Note 49)The system according to Supplementary Note 1, wherein the system unit is configured to perform an appropriate billing setting based on past billing data when managing the billing system.
(Supplementary Note 50)The system according to Supplementary Note 1, wherein the system unit is configured to estimate an emotion of a user and determine a priority of the billing system based on the estimated emotion of the user.
(Supplementary Note 51)The system according to Supplementary Note 1, wherein the system unit is configured to perform weighting of the billing setting based on a submission time of the advertising creative when managing the billing system.

What is claimed is:

1. A system comprising:
a communication interface configured to communicate with a client terminal via a packet-switched network;
a processor;
a random-access memory;
a memory storing a data generation model obtained by deep learning on a neural network, and an emotion identification model;
a database storing reference feature vectors associated with compliance criteria; and
circuitry configured to:
receive, from the client terminal via the communication interface, content data comprising at least one of image data, text data, or video data;
extract, using a feature extractor comprising at least one of a convolutional neural network or a Transformer-based model, a feature vector from the content data;
compare the extracted feature vector with the reference feature vectors stored in the database by calculating a similarity metric to generate a compliance score indicating a degree of compliance of the content data with the compliance criteria;
generate, using the data generation model, corrected content data by locally correcting a region of the content data identified as non-compliant based on the compliance score; and
transmit the corrected content data to the client terminal via the communication interface and the packet-switched network.

2. The system according to claim 1, wherein the feature extractor comprises a convolutional neural network for extracting a visual feature vector from the image data and a Transformer-based large language model for extracting a contextual embedding vector from the text data.

3. The system according to claim 1, wherein the similarity metric comprises at least one of a cosine similarity or a Euclidean distance between the extracted feature vector and the reference feature vectors, and wherein the compliance score comprises a probability of non-compliance.

4. The system according to claim 1, wherein the circuitry is further configured to generate the corrected content data by applying at least one of an inpainting model to locally rewrite an image region identified as non-compliant, or a sequence-to-sequence model to rewrite a text portion identified as non-compliant.

5. The system according to claim 1, wherein the circuitry is further configured to generate a plurality of corrected content data candidates, input each candidate into the feature extractor to generate a candidate compliance score, and select a candidate having a highest candidate compliance score as the corrected content data.

6. The system according to claim 1, wherein the circuitry is further configured to apply different feature extractors according to a modality of the content data, such that for the image data, the circuitry applies a convolutional neural network or a Vision Transformer, for the text data, the circuitry applies a Transformer-based language model, and for the video data, the circuitry applies a three-dimensional convolutional neural network.

7. The system according to claim 1, wherein the circuitry is further configured to perform cross-modal analysis on the content data when the content data comprises both image data and text data, the cross-modal analysis comprising evaluating a semantic consistency between the image data and the text data using a multimodal learning model.

8. The system according to claim 1, wherein the circuitry is further configured to estimate an emotion of a user by applying the emotion identification model to at least one of voice data, a face image, or text input received from the client terminal, and to adjust a representation method of the compliance score based on the estimated emotion.

9. The system according to claim 8, wherein the circuitry is further configured to adjust a strictness of the compliance criteria based on the estimated emotion, such that when the estimated emotion indicates relaxation, the circuitry applies a stricter compliance threshold, and when the estimated emotion indicates stress, the circuitry applies a relaxed compliance threshold.

10. The system according to claim 1, wherein the circuitry is further configured to adjust a level of detail of the comparison based on an importance score associated with the content data, such that for content data having a high importance score, the circuitry applies a large-scale model with a high number of parameters, and for content data having a low importance score, the circuitry applies a lightweight distilled model.

11. The system according to claim 1, wherein the circuitry is further configured to update the compliance criteria stored in the database by analyzing new regulation documents using a natural language processing model to extract feature vectors of prohibited patterns, and adding the extracted feature vectors to the reference feature vectors in the database.

12. The system according to claim 1, wherein the circuitry is further configured to apply different correction algorithms according to a modality of the non-compliant region, such that for a non-compliant image region, the circuitry applies an image generation model with an inpainting function, and for a non-compliant text portion, the circuitry applies a large language model to generate a replacement text portion.

13. The system according to claim 1, wherein the circuitry is further configured to estimate an emotion of a user by applying the emotion identification model to sensor data received from the client terminal, and to adjust a tone of the corrected content data based on the estimated emotion.

14. The system according to claim 1, wherein the circuitry is further configured to determine a priority of generating the corrected content data based on a submission time associated with the content data, such that content data having a more recent submission time is processed with a higher priority.

15. The system according to claim 1, wherein the circuitry is further configured to identify a geographic region associated with the content data and to compare the extracted feature vector with a subset of the reference feature vectors corresponding to compliance criteria specific to the identified geographic region.

16. The system according to claim 1, wherein the circuitry is further configured to retrieve, from the database, attribute information of a submitter of the content data, and to adjust a processing flow for the comparison based on a trust score calculated from a past compliance history of the submitter.

17. The system according to claim 1, wherein the circuitry is further configured to search a vector database using a retrieval-augmented generation architecture to acquire reference documents related to the content data, and to input the acquired reference documents together with the extracted feature vector into the data generation model to generate the corrected content data.

18. A system comprising:
a communication interface configured to communicate, via a packet-switched network conforming to at least one of a 5G, Wi-Fi, or Bluetooth communication standard, with a client terminal comprising a camera having a CMOS image sensor, a touch panel, a microphone, a speaker, and a display;
a processor;
a random-access memory;
a memory storing a data generation model obtained by deep learning on a neural network, and an emotion identification model;
a database storing reference feature vectors associated with compliance criteria; and
circuitry configured to:
receive, from the client terminal via the communication interface, content data comprising at least one of image data, text data, or video data;
extract, using a feature extractor comprising at least one of a convolutional neural network or a Vision Transformer for the image data and a Transformer-based large language model for the text data, a feature vector from the content data;
compare the extracted feature vector with the reference feature vectors stored in the database by calculating at least one of a cosine similarity or a Euclidean distance to generate a compliance score;
estimate an emotion of a user by applying the emotion identification model to at least one of voice data captured by the microphone or image data captured by the camera;
generate, using the data generation model, corrected content data by locally correcting a region of the content data identified as non-compliant based on the compliance score, the corrected content data being adapted based on the estimated emotion; and
transmit the corrected content data to the client terminal via the communication interface, the corrected content data causing the client terminal to present the corrected content data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a data processing system comprising a processor, a random-access memory, a memory storing a data generation model obtained by deep learning on a neural network and an emotion identification model, a database storing reference feature vectors associated with compliance criteria, and a communication interface, the method comprising:
receiving, from a client terminal via the communication interface and a packet-switched network, content data comprising at least one of image data, text data, or video data;
extracting, using a feature extractor comprising at least one of a convolutional neural network or a Transformer-based model, a feature vector from the content data;
comparing the extracted feature vector with the reference feature vectors stored in the database by calculating a similarity metric to generate a compliance score indicating a degree of compliance of the content data with the compliance criteria;
generating, using the data generation model, corrected content data by locally correcting a region of the content data identified as non-compliant based on the compliance score; and
transmitting the corrected content data to the client terminal via the communication interface and the packet-switched network.
